(19) United States
(12) Patent Application Publication
(10) Pub. No.: US 2024/0127142 A1
(43) Pub. Date: Apr. 18, 2024

(54) METHOD AND PLATFORM FOR PROVIDING CURATED WORK OPPORTUNITIES

(71) Applicant: The Builders Network LLC, Marietta, GA (US)

(72) Inventor: Tommy Pease, Marietta, GA (US)

(21) Appl. No.: 18/485,507

(22) Filed: Oct. 12, 2023

Related U.S. Application Data
(60) Provisional application No. 63/415,957, filed on Oct. 13, 2022.

(51) Int. Cl. G06Q 10/0631

(52) U.S. Cl. CPC G06Q 10/063112

(57) ABSTRACT

The present disclosure provides a platform for providing curated work opportunities. The platform receives contractor bid data comprising information related to work a contractor is interested in performing, and contractor legacy data relating to one or more past work opportunities associated with the contractor. The contractor requests a recommendation of one or more work opportunities for which the contractor should apply. The platform associates the contractor bid data and the contractor legacy data with one or more learned contractor profiles trained by an Artificial Intelligence engine, establishes one or more parameters for assessing the plurality of candidate work opportunities based at least in part on one or more of the contractor bid data or the contractor legacy data, and analyzes each of a plurality of candidate work opportunities based on the parameters. Thereafter the platform provides a recommendation of one or more of the candidate work opportunities to the contractor.

### RELATED APPLICATION

Under provisions of 35 U.S.C. § 119(e), the Applicant claims benefit of U.S. Provisional Application No. 63/415,957 filed on Oct. 13, 2022, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to project bidding, project management, and machine learning.

### BACKGROUND

In some situations, contractors have a desire to bid for work opportunities that best fit their preferences and skills. For example, a contractor may only desire work opportunities within a certain location, requiring a certain level of qualification, and/or within a certain work opportunity size.

The conventional strategy is to manually search through work opportunities. This often causes problems because the conventional strategy does not account for the lack of ability to filter and/or receive recommendations based on the contractor's preferences. Moreover, it can be difficult and impractical to search through the various resources that list work opportunities. Still further, some companies needing work performed may not know where to look for contractors to perform the work.

Moreover, once the contractor has secured one or more work opportunities, the work opportunities or projects may have actively dynamic factors that can provide challenges, necessitate adjustment, and require extensive organization. For example, a general contractor overseeing a project having subcontractors and various resources required for the project will assume significant project management roles.

Traditionally, a general contractor and/or developer will be required to setup and manage all documentation, procurement, scheduling, and contracts manually. During a project lifecycle, the general contractor may encounter delays and/or unforeseeable developments forcing a deviation from the originally planned schedule. Thus, the conventional strategy is to manually adjust each of the affected items (e.g., schedules, documentation, procurement, and/or contracts) based on the delays from the subcontractor's schedule and/or timing for delivery of resources. Further, the resources, timeline, and documentation relating to a newly executed contract require manual integration into the existing data after each creation of a new contract. This often causes problems because the conventional strategy requires significant setup time, and does not account for the precision and adjustment necessary to coordinate and correct timing, execution, and delivery of various factors and resources, in addition to the secondary consequences of such adjustments.

Accordingly, a method and platform for recommending work opportunities that match the contractor with work opportunities that best match the contractor's requirements and/or preferences for work is needed. A method and platform for dynamic automation and persistent purchasing, adjusting, and coordinating of various aspects in a project is needed.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure provides a method for providing curated work opportunities comprising: receiving contractor bid data from a contractor, the contractor bid data comprising one or more of the following: a CSI division, a scope of work, a service performed, one or more qualifications, supporting documentation, a geolocation, one or more resources to be used, and an availability time frame; receiving contractor legacy data relating to past work opportunities and projects and contracts associated with the contractor; receiving a request, by the contractor, for a recommendation of one or more work opportunities from a plurality of work opportunities, each of the plurality of work opportunities comprising one or more of the following: one or more work types, a CSI division, a bid start date, a start date, one or more qualification requirements, a geolocation, an opportunity scope overview, deliverables, supporting documentation, and an internal cost estimate, and a parent project; associating the contractor bid data and the contractor legacy data with one or more learned contractor profiles trained by an Artificial Intelligence (AI) engine; establishing one or more parameters for assessing the plurality of work opportunities, the one or more parameters comprising one or more of the following: a minimum correlation between the one or more learned contractor profiles and each of the plurality of work opportunities, and a predetermined range of association of weighted factors between the one or more learned contractor profiles and each of the plurality of work opportunities; analyzing each of the plurality of work opportunities in accordance with the one or more parameters; and providing the contractor with the recommendation of one or more of the plurality of work opportunities.

In another aspect, the present disclosure provides a method for providing curated work opportunities comprising: receiving contractor bid data from a contractor, the contractor data comprising one or more of the following: a CSI division, a scope of work, a service performed, one or more qualifications, supporting documentation, a geolocation, an availability time frame; receiving a request, by the contractor, for a recommendation of one or more work opportunities from a plurality of work opportunities, each of the plurality of work opportunities comprising one or more of the following: one or more work types, a CSI division, a bid start date, a start date, one or more qualification requirements, a geolocation, an opportunity scope overview, deliverables, supporting documentation, and an internal cost estimate; associating the contractor bid data with a learned contractor profile trained with contractor legacy data relating to past work opportunities and projects and contracts associated with the contractor by an Artificial Intelligence (AI) engine; establishing one or more parameters for assessing the plurality of work opportunities in accordance with the associated contractor bid data, the one or more parameters comprising one or more of the following: a minimum correlation between the associated contractor data and each of the plurality of work opportunities, and a predetermined range of association of weighted factors between the one or more learned contractor profiles and each of the plurality of work opportunities; analyzing each of the plurality of work opportunities in accordance with the one or more parameters; providing the contractor with the recommendation of one or more of the plurality of work opportunities.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of a platform 100;

FIG. 2 shows the operation of the platform 100;

FIG. 3 illustrates signup and profile creation within a profile module 200;

FIG. 4 further illustrates the profile module 200;

FIG. 5 further illustrates the profile module 200;

FIG. 6 further illustrates the profile module 200;

FIG. 7 illustrates a work opportunity module 300;

FIG. 8 further illustrates the work opportunity module 300;

FIG. 9 further illustrates the work opportunity module 300;

FIG. 10 illustrates the bidding module 400;

FIG. 11 further illustrates the bidding module 400;

FIG. 12 further illustrates the bidding module 400;

FIG. 13 illustrates at least a portion of a marketplace module 500, showing one or more users;

FIG. 14 illustrates at least a portion of the marketplace module 500, showing one or more products;

FIG. 15 illustrates at least a portion of the marketplace module 500 showing one or more projects;

FIG. 16 illustrates a transition from work opportunity module 300, to the contract module 600, responsive to a selection of “draft contract” by the user;

FIG. 17 further illustrates a contract module 600;

FIG. 18 further illustrates the contract module 600;

FIG. 19 further illustrates a workflow module 700, initiated subsequent to the contract being executed;

FIG. 20 illustrates another aspect of the workflow module 700, a submittal log;

FIG. 21 illustrates another aspect of the workflow module 700, a resource management module;

FIG. 22 further illustrates the workflow module 700; initiated subsequent to the contract being executed;

FIG. 23 is a flow chart of a method 1000 for providing curated work opportunities;

FIG. 24 is a flow chart of a method 2000 for operational persistent data flow; and

FIG. 25 is a block diagram of a system including a computing device for use of the platform 100, the method 1000 of FIG. 23, and/or the method 2000 of FIG. 24.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to what an ordinary artisan would understand such a term to mean based on the contextual use of such a term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of data flow and project management, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure relates to a system and/or platform 100 for providing curated work opportunities. The platform may use Artificial Intelligence (AI) to determine projects that a particular contractor may find of interest based on project information from projects completed by the contractor, explicit specifications from the contractor, and/or other contractor profiles similar to the contractor. The project information may be internal to the system or received from an external data source. When creating a bid, the platform 100 may recommend resources and/or work items to be placed into the bid based on a contractor familiarity with the resources and/or developer resource preferences and/or data specific to the work opportunity. Once a contractor places a bid comprising resources and work to be completed, the bid may be accepted by a developer.

Additionally or alternatively, the present disclosure may relate to a system and/or platform for tracking projects with operational persistent data flow. Aspects of tracking such projects may include building project specifications, receiving bids on specified projects, creating contracts for bid winners, thereby automating project management workflows, and tracking project completion. The platform facilitates developers and service providers (e.g., builders) in creating work opportunities to which contractors and subcontractors may submit bids. Once a contractor places a bid comprising work to be completed and resources needed to complete the work, the bid may be accepted by the developer. Upon acceptance, the system may transform the bid into a contract, using the resources and work entered by the contractor, and submit the contract for the two parties (e.g., the contractor and the developer) to sign. The system may track resources to be used and work to be performed and may provide recommendations for when to order resources specified in the contract and/or when to begin work items promised under the contract to maintain an on-time project completion. After contracts are created, the work opportunity and data related to the work opportunity are integrated into a series of workflows for the project. The workflows may include setting up various project management structures relating to the resources and work outlined in the contract. one or more of a schedule (and/or updates to existing schedule), a procurement log, and/or a payment schedule may be automated. Parties within a contract may be added to the project, and/or resource data from the contract may be stored to the project. Any changes relating to the contractor and/or resources required for the work opportunity and/or project are automatically reflected in the workflow, and the workflow is adjusted accordingly. The platform may have a persistent (e.g., continuous and/or periodic) checking of internal and external data sets relating to aspects of the project, as to provide real time updates and adjustments as changes to the aspects of the project occur. In response to the persistent checking, any document or project management workflow where the updated resource is located may be configured to adjust accordingly.

Embodiments of the present disclosure may comprise methods, systems, and a computer readable medium comprising, but not limited to, at least one of the following:
A. A Profile Module 200;
B. A Work Opportunity Module 300;
C. A Bidding Module 400; and
D. A Marketplace Module 500;

In some embodiments, the present disclosure may provide an additional set of modules for further facilitating the software and hardware platform. The additional set of modules may comprise, but not be limited to, one or more (e.g., each) of the following:
E. A Contract Module 600; and
F. A Workflow Module 700.

Details with regards to each module are provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:
receiving contractor bid data from a contractor, the contractor bid data comprising one or more of the following:
   a CSI division,
   a scope of work,
   a service performed,
   a geolocation,
   one or more resources to be used, and
   an availability timeframe;
receiving contractor legacy data relating to past work opportunities, projects, and contracts associated with the contractor;
receiving a request, by the contractor, for a recommendation of one or more work opportunities from a plurality of work opportunities, each of the plurality of work opportunities comprising one or more of the following:
   one or more work types,
   a CSI division,
   a bid start date,
   a start date,
   one or more qualification requirements,
   a geolocation,
   an opportunity scope overview,
   deliverables,
   supporting documentation, and
   an internal cost estimate;
associating the contractor bid data and the contractor legacy data with one or more learned contractor profiles trained by an Artificial Intelligence (AI) engine;
establishing one or more parameters for assessing the plurality of work opportunities, the one or more parameters comprising one or more of the following:
   a minimum correlation between the one or more learned contractor profiles and each of the plurality of work opportunities, and
   a predetermined range of association of weighted factors between the one or more learned contractor profiles and each of the plurality of work opportunities;
analyzing each of the plurality of work opportunities in accordance with the one or more parameters; and
providing the contractor with the recommendation of one or more of the plurality of work opportunities.

Additionally or alternatively, a second method may be performed by at least one of the modules disclosed herein. The second method may be embodied as, for example, but not limited to, computer instructions, which when executed, perform the method. The method may comprise the following stages:
building a plurality of specifications for a project, the building comprising defining one or more work opportunities, each of the one or more opportunities comprising one or more of the following:
   one or more work types,
   a CSI division,
   a bid start date,
   a start date,
   one or more qualification requirements,
   a geolocation,
   an opportunity scope overview,
   deliverables,
   supporting documentation, and
   an internal cost estimate,
   a parent project, and
   one or more proposals received;
for each of the one or more opportunities, receiving one or more proposals;
determining one proposal for each of the one or more opportunities;
assembling, in accordance with each determined proposal and the plurality of specifications of the project, a plurality of resources necessitated for the project;
for each of the plurality of resources, calculating resource data, the resource data comprising one or more of the following:
   a resource name,
   a lead time,
   a delivery date,
   a latest date to order the resource,
   a unit of measurement,
   a current status,
   a CSI division for organizational and management purposes,
   a manufactured product having seller information and manufacturer information,
   the corresponding proposal,
   a seller,
   a manufacturer, and
   a specifications;
establishing a procurement schedule of the plurality of resources in accordance with the calculated resource data;
establishing a project schedule having the following integrated into the project schedule:
   the resource data from each of the plurality of resources,
   the procurement schedule, and
   each determined proposal;
determining a payment schedule for the plurality of resources, the payment schedule having:
   a first payment arrangement for a developer of the project to a contractor of each of the determined proposals, and
   a second payment arrangement for the contractor to a supplier associated with each of the plurality of resources related to the contractor;
receiving an indication of a change relating to one or more of the plurality of resources, the change comprising one or more of the following:
   an inventory deficiency,
   a delivery date modification, and
   a lead time change; and
responsive to receiving the indication of the change:
   updating at least a portion of the resource data, and
   adjusting one or more of the following:
      at least a portion of the procurement schedule,
      at least a portion of the project schedule, and
      at least a portion of the payment schedule.

Though the aforementioned methods have been described to be performed by the platform 100, it should be understood that computing device 900 may be used to perform the various stages of one or more of the methods. Furthermore, in some embodiments, different operations may be performed by different networked elements in operative communication with computing device 900. For example, a plurality of computing devices may be employed in the performance of some or all of the stages in one or more of the aforementioned methods. Moreover, a plurality of computing devices may be configured much like a single computing device 900. Similarly, an apparatus may be employed in the performance of some or all stages in one or more of the methods. The apparatus may also be configured much like computing device 900.

Both the foregoing overview and the following detailed description provide examples and are explanatory only. Accordingly, the foregoing overview and the following detailed description should not be considered restrictive. Further, features or variations may be provided in addition to those set forth herein. For example, embodiments may be directed to various feature combinations and sub-combinations described in the detailed description.

### II. Platform Configuration

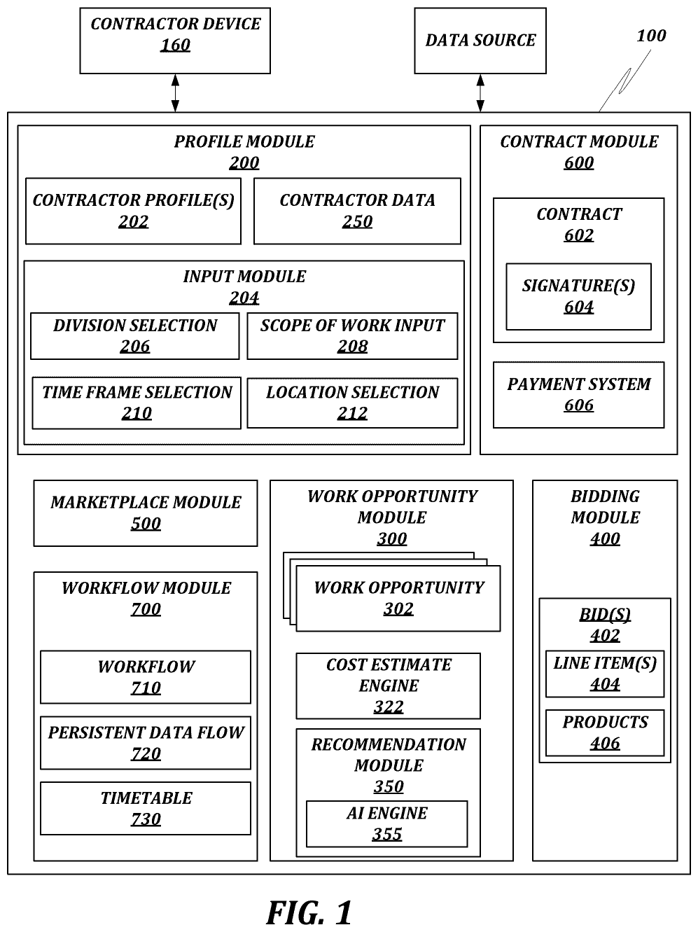

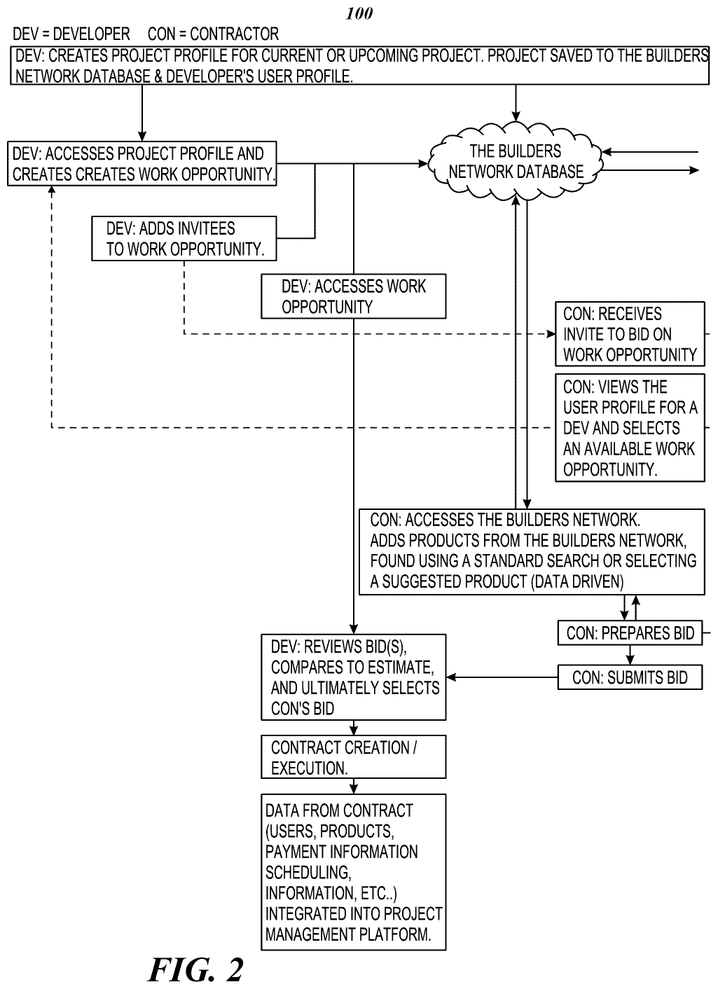

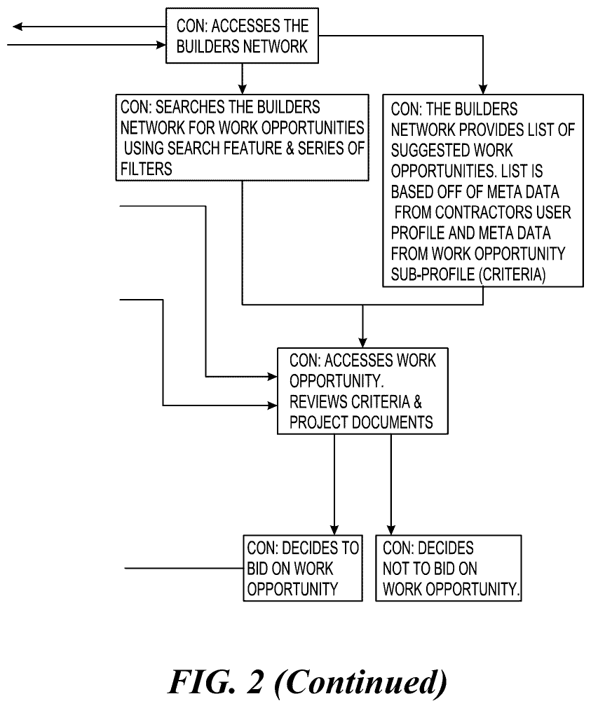

FIGS. 1 and 2 illustrate one possible operating environment through which a platform consistent with embodiments of the present disclosure may be provided. By way of non-limiting example, a platform 100 may be hosted on, for example, a cloud computing service. In some embodiments, the platform 100 may be hosted on a computing device (e.g., the computing device 900). A user may access platform 100 through a software application and/or hardware device. The software application may be embodied as, for example, but not be limited to, a website, a web application, a desktop application, and a mobile application compatible with the computing device 900. One possible embodiment of the software application and/or hardware device may be provided by the suite of products and services provided by The Builders Network LLC.

The term “builder” may be embodied as, and be used interchangeably with, various other terms including (but not limited to), for example, a general contractor, a foreman, a team leader, a project manager, and/or a developer.

It is further noted that the term “contractor” may be embodied as, and may be used interchangeably with, various other terms including (but not limited to), for example, a subcontractor, a laborer, and/or a skilled laborer.

Embodiments of the present disclosure provide a software and hardware platform comprised of a distributed set of computing elements, including, but not limited to:

A. Profile Module 200

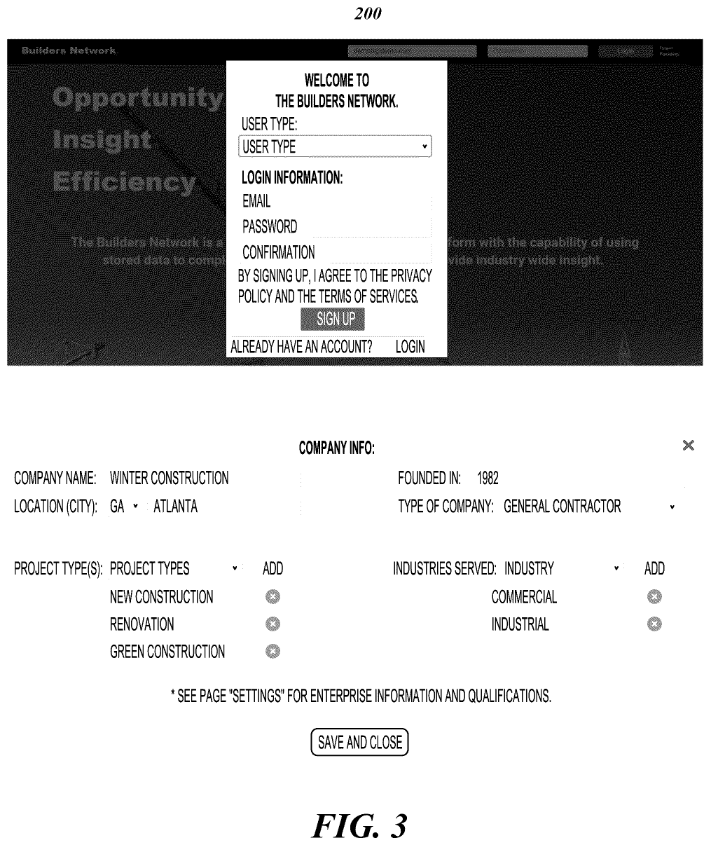

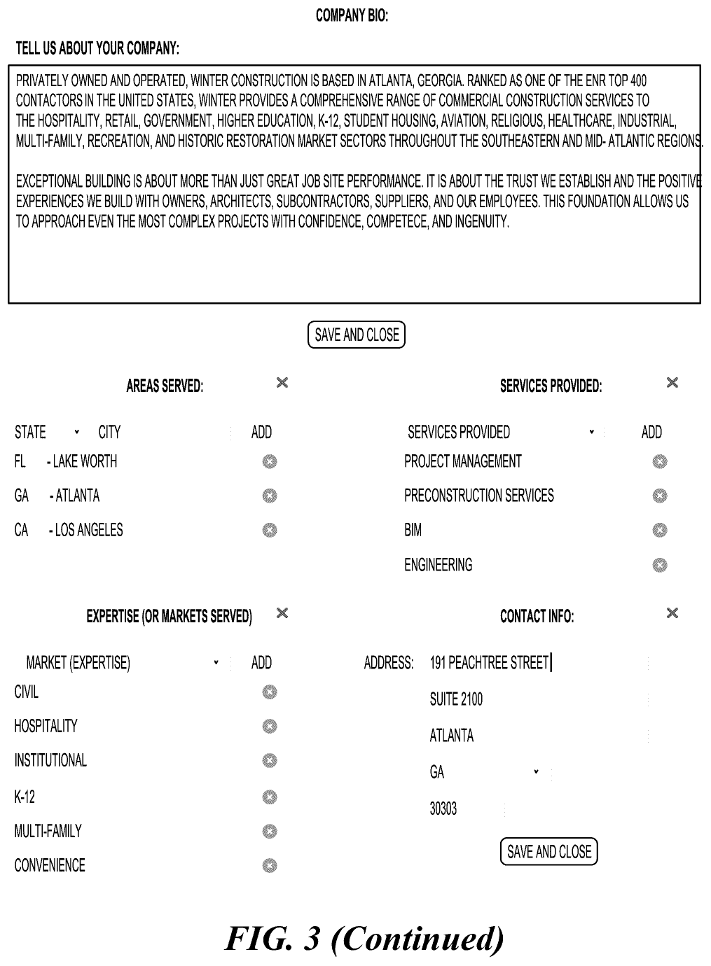

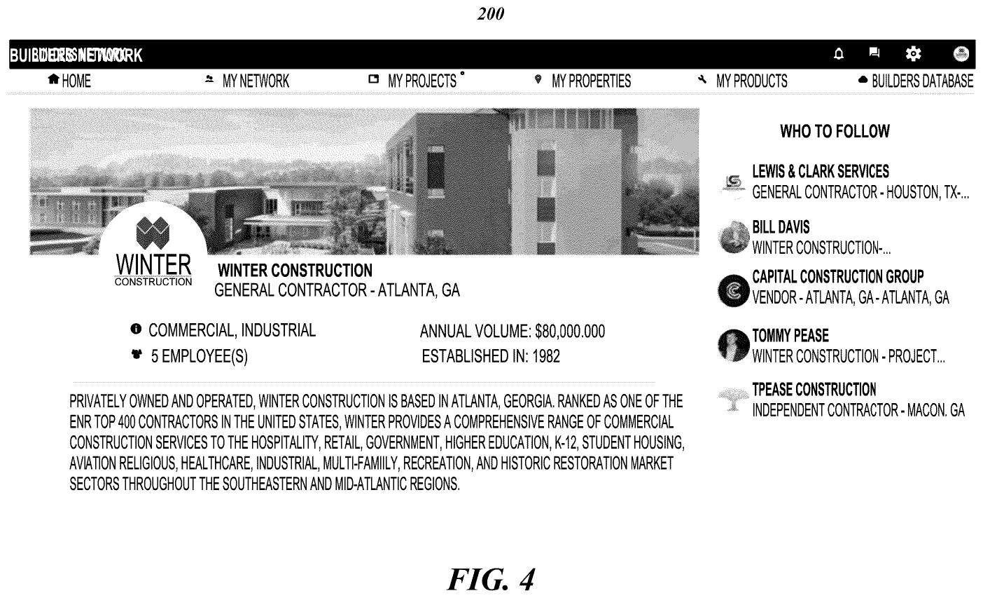

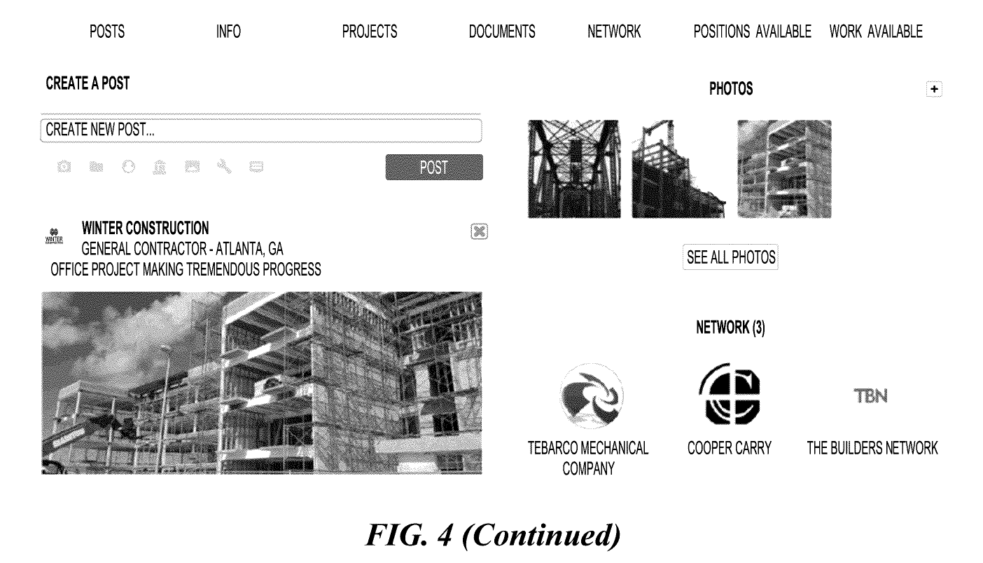

FIGS. 1-4 illustrate the profile module 200 consistent with an embodiment of the present disclosure. The profile module 200 may include hardware and/or software used (e.g., by a contractor 160) to facilitate and/or create a contractor profile 202.

In some embodiments, the profile module 200 may comprise an input module 204. The input module may be used to receive a plurality of information and/or data related to the contractor 160 for integration into the contractor profile 202.

In further embodiments, the input module 204 may comprise a division selection 206. The division selection 206 may be used to specify a particular Construction Specifications Institute (“CSI”) division the contractor 160 is qualified for (and/or proficient in). Some nonlimiting examples of CSI divisions are, for example, concrete, masonry, metals, and wood and plastics.

In further embodiments, the input module 204 may comprise a scope of work input 208. The scope of work input 208 may be used to specify one or more predetermined ranges of services willing to, desired, and/or qualified to perform. By way of nonlimiting example, the scope of work input may be embodied as, but not limited to, for example, one or more of the following:
a. size of site,
b. number of buildings,
c. square footage,
d. building height,
e. levels,
f. frame type,
g. skin type,
h. window system,
i. roof system,
j. parking spaces,
k. parking structure,
l. stories above grade, and
m. stories below grade.

In further embodiments, the input module 204 may comprise a timeframe availability selection 210. The timeframe availability selection 210 may be used to indicate one or more (estimated) timeframes and/or schedules of availability to work on one or more of a plurality of work opportunities 302.

In further embodiments, the input module 204 may comprise a location specification 212. The location specification 212 may be used to determine a geolocation, radius, and/or distance willing to travel (e.g., state, county, municipality) for bidding and/or performance of one or more of the plurality of work opportunities 302.

In further embodiments, the profile module 200 may comprise a contractor data module 250. The contractor data module 250 may be used to store and/or facilitate access to data (e.g., metadata) received at least a portion of data received and/or inputted via the input module 204.

The contractor data module 250 may be further used to store and/or facilitate access to legacy data relating to the contractor 160 and/or past work opportunities (and/or contracts and/or projects) associated with the contractor 160. By way of nonlimiting example, legacy data relating to past work opportunities, projects and/or contracts associated with the contractor 160 may be embodied as, name(s) of manufacturers, items used, size of the project (work opportunity), location (state, county, municipality).

The contractor data module 250 may be further used to store and/or facilitate access to legacy data relating to other contractors.

In further embodiments, the profile module 200 may be configured to transmit at least a portion of aspects and/or data relating to the profile module 200 to the workflow module 400.

B. Work Opportunity Module 300

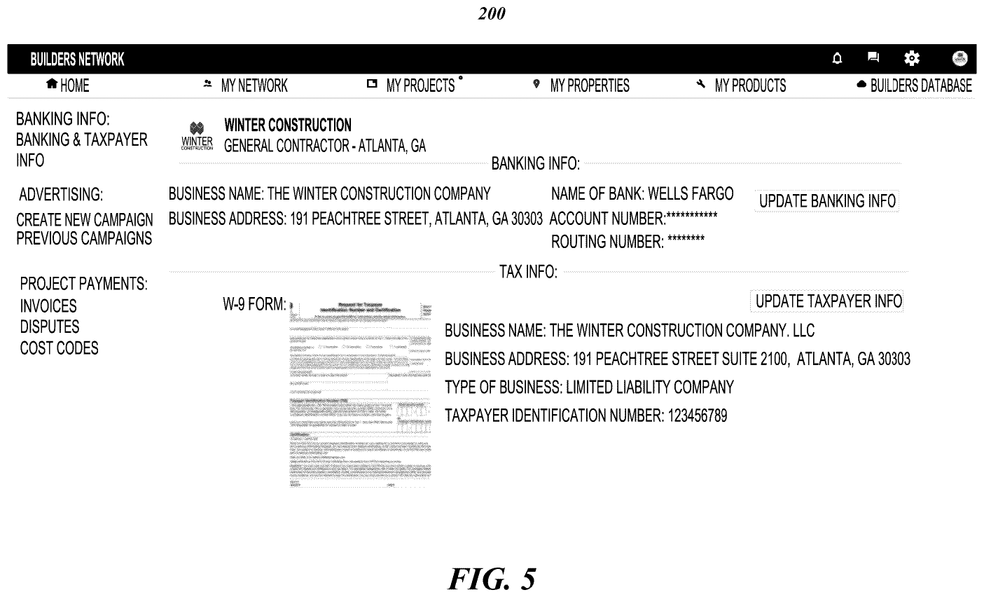

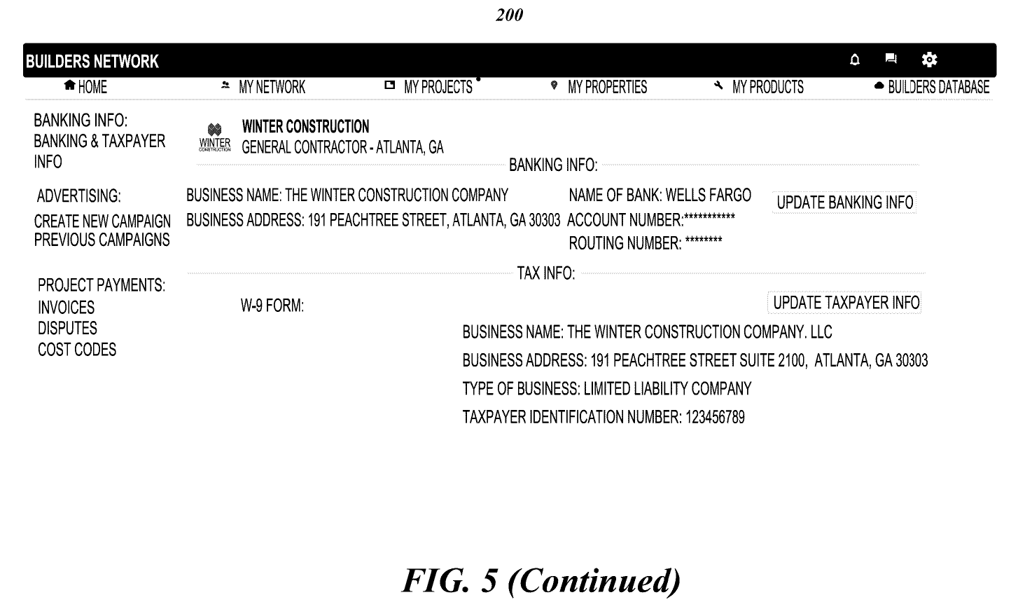

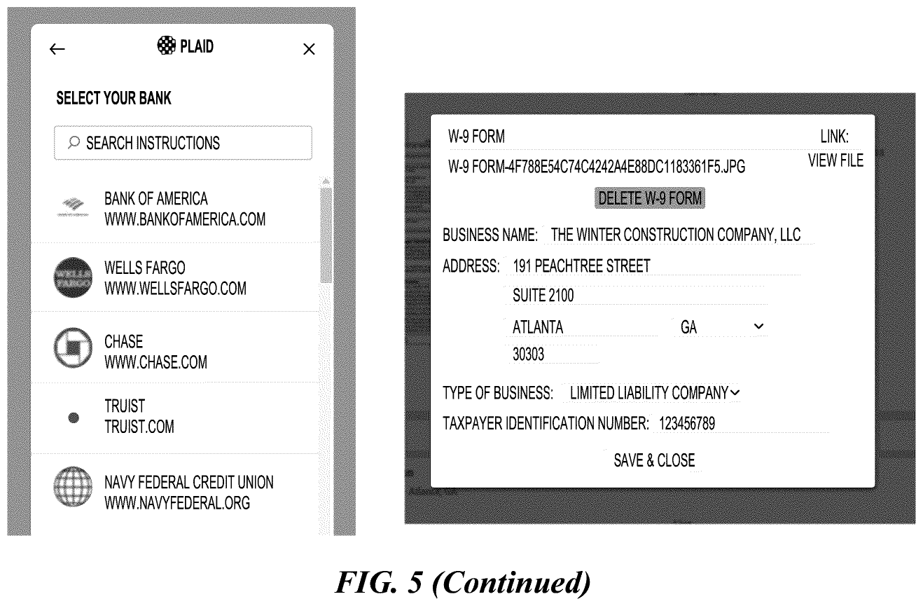

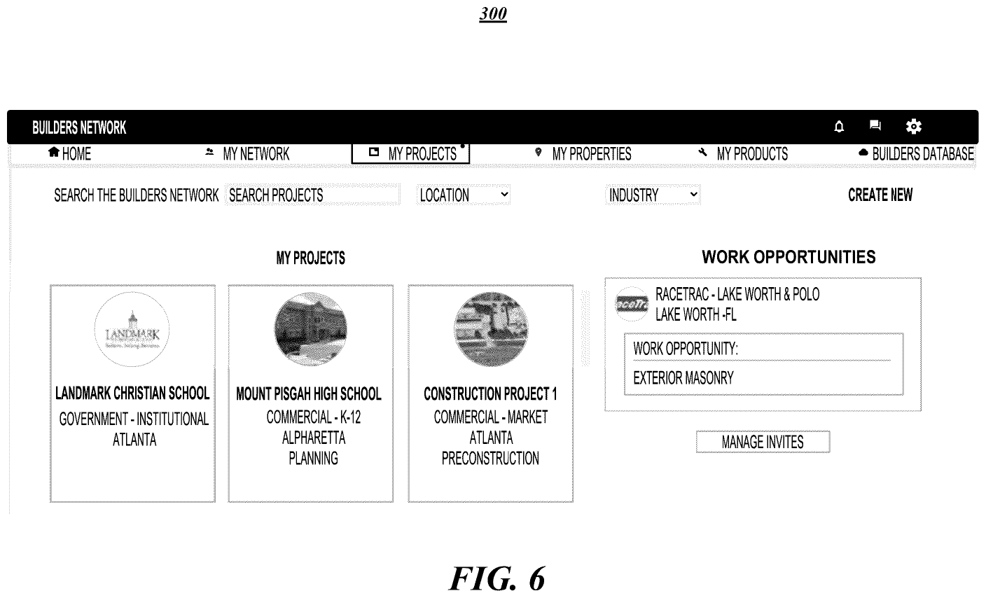

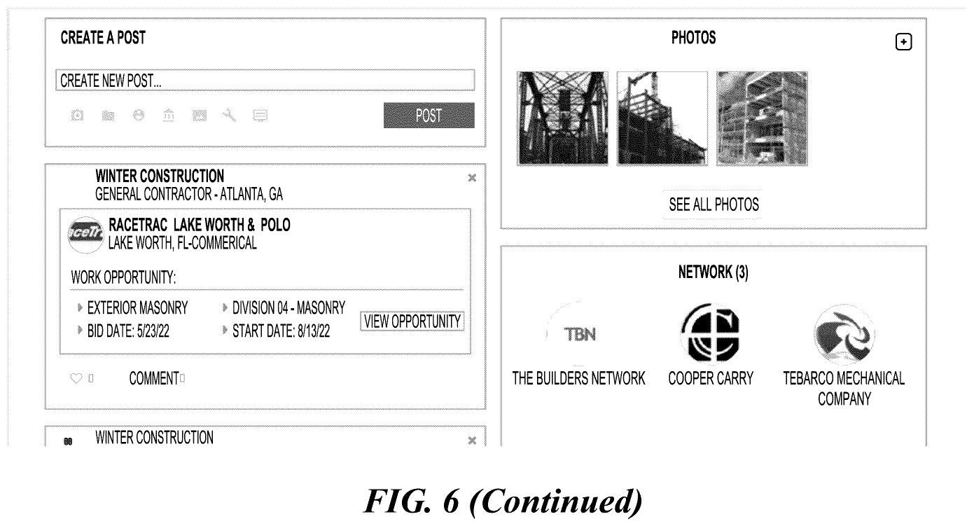

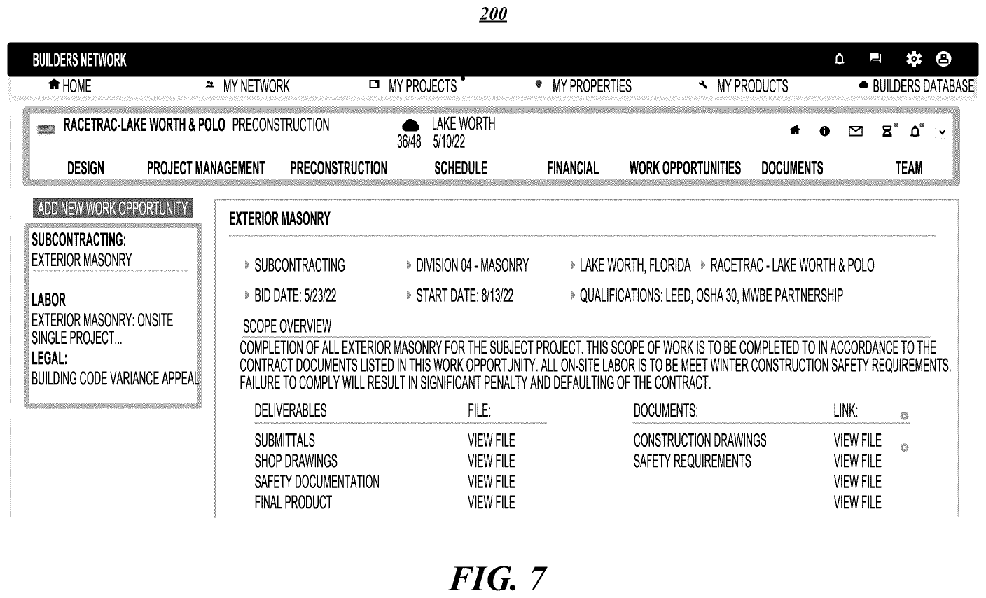

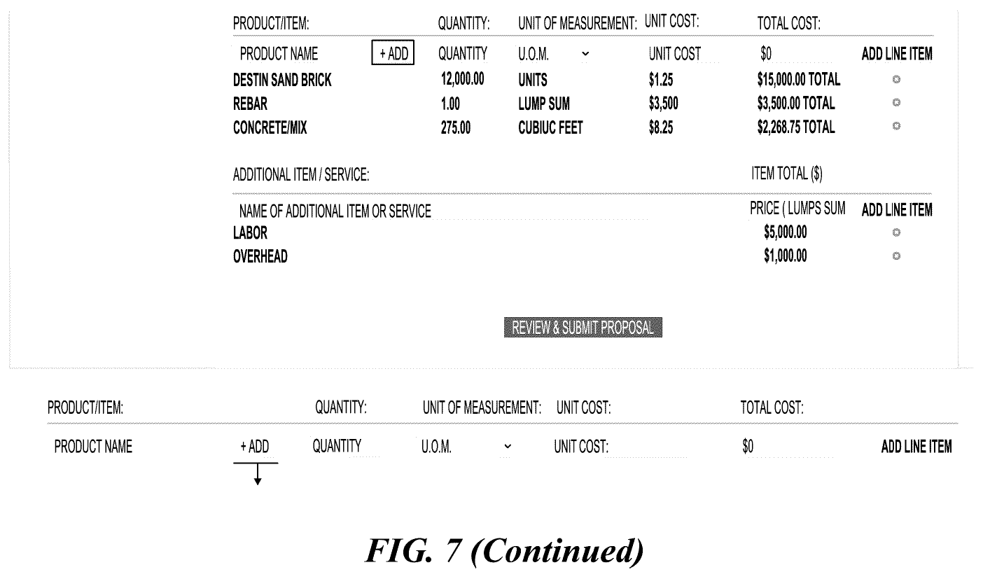

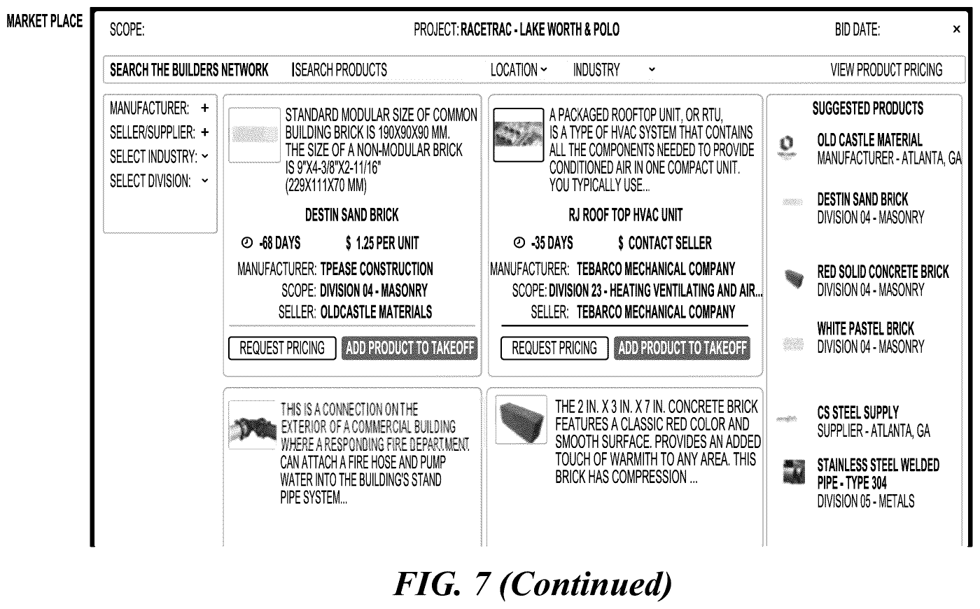

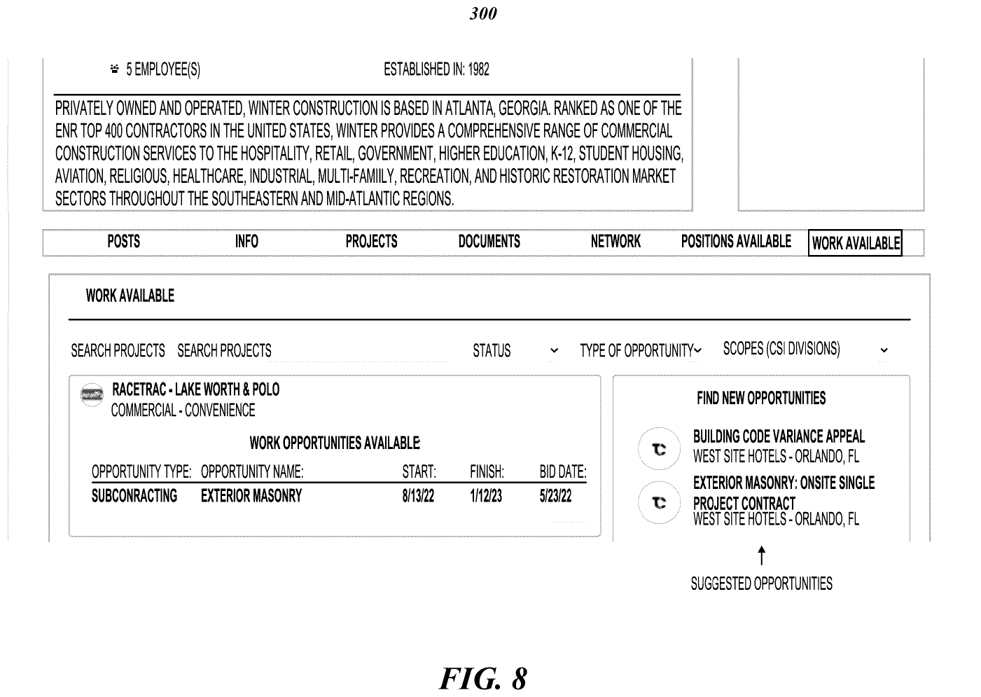

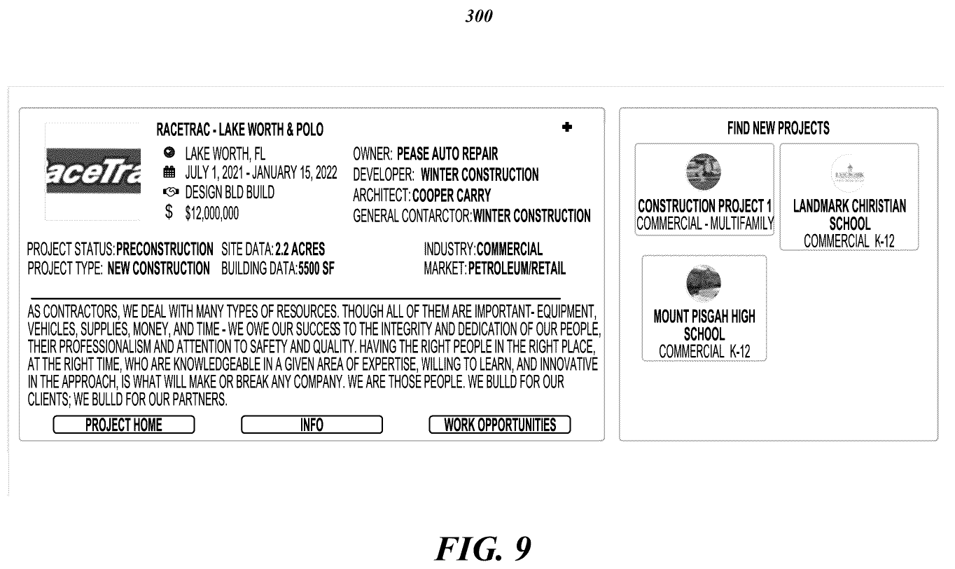

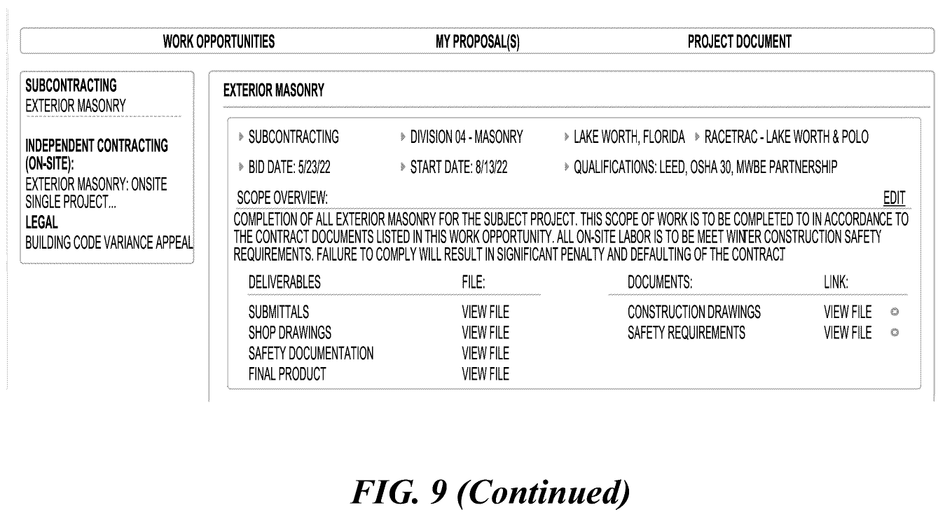

FIGS. 1-2 and 5-9 illustrate the work opportunity module 300 consistent with an embodiment of the present disclosure. In some embodiments, the work opportunity module 300 comprises hardware and/or software that may comprise and/or provide access to a plurality of work opportunities 302. Each of the plurality of work opportunities 302 may be embodied as a contractor job request (relating to a project 150) with various specifications required for said job.

In further embodiments, at least a portion of the plurality of work opportunities 302 may comprise a division specification 306. The division specification 306 may be used to specify and/or require a particular Construction Specifications Institute (“CSI”) division for one or more of the plurality of work opportunities 302.

In further embodiments, at least a portion of the plurality of work opportunities 302 may comprise a bid date specification 208. The bid date specification 208 may be used to specify a predetermined timeframe and/or date range to allow bidding and/or receipt of one or more bids (and/or offers) for one or more of the plurality of work opportunities 302.

In further embodiments, at least a portion of the plurality of work opportunities 302 may comprise a start date selection 210. The start date selection 210 may be used to indicate a (estimated) timeframe to begin one or more of the plurality of work opportunities 302.

In further embodiments, at least a portion of the plurality of work opportunities 302 may comprise a qualification selection 312. The qualification selection 312 may be used to specify one or more predetermined qualifications required for performing the one or more work opportunities 302.

In further embodiments, at least a portion of the plurality of work opportunities 302 may comprise a location specification 314. The location specification 314 may be used to specify a geolocation and/or site for performance of one or more of the plurality of work opportunities 302. In some embodiments, the location specification 314 may be received from the parent project.

In further embodiments, at least a portion of the plurality of work opportunities 302 may comprise a scope overview entry 316. The scope overview 316 may provide details, descriptions, and/or outlines of one or more of the plurality of work opportunities 302.

In further embodiments, at least a portion of the plurality of work opportunities 302 may comprise a deliverables requirement 318. The deliverables requirement 318 may quantify and/or specify the end-result of one or more of the plurality of work opportunities 302.

In further embodiments, at least a portion of the plurality of work opportunities 302 may comprise a document upload option 320. The document upload option may be used to retrieve, attach, and/or upload any documentation (e.g., drawings, specifications) related to the one or more of the plurality of work opportunities 302.

In some embodiments, at least a portion of the parent and/or overall project (and its corresponding data/specifications) may be accessible through the one or more work opportunities 302.

In further embodiments, the work opportunity module 300 may comprise a recommendation module 350. The recommendation module 350 may be used to generate recommendations of one or more of the plurality of work opportunities 302 to the contractor 160.

In some embodiments, the recommendation module 350 may be configured to receive the legacy data relating to the contractor 160 and/or past work opportunities, projects, and/or contracts associated with the contractor 160.

In some embodiments, the recommendation module 350 may comprise an Artificial Intelligence (AI) engine 355. The AI engine 355 may be used to perform machine learning techniques on various data relating to the recommendation module 350.

In an embodiment, the AI engine 355 may use a machine learning engine. Machine learning includes various techniques in the field of artificial intelligence that deal with computer-implemented, user-independent processes for solving problems that have variable inputs.

In some embodiments, the machine learning engine trains a machine learning model to perform one or more operations. Training a machine learning model may use training data to generate a function that, given one or more inputs to the machine learning model, computes a corresponding output. The output may correspond to a prediction based on prior machine learning. In an embodiment, the output includes a label, classification, and/or categorization assigned to the provided input(s). The machine learning model corresponds to a learned model for performing the desired operation(s) (e.g., labeling, classifying, and/or categorizing inputs). The AI engine 355 may use multiple machine learning engines and/or multiple machine learning models for different purposes.

In an embodiment, the machine learning engine may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine receives positive and/or negative reinforcement in the process of attempting to solve a particular problem (e.g., to optimize performance in a particular scenario, according to one or more predefined performance criteria). In an embodiment, the machine learning engine initially uses supervised learning to train the machine learning model and then uses unsupervised learning to update the machine learning model on an ongoing basis.

In an embodiment, a machine learning engine may use many different techniques to label, classify, and/or categorize inputs. A machine learning engine may transform inputs into feature vectors that describe one or more properties (“features”) of the inputs. The machine learning engine may label, classify, and/or categorize the inputs based on the feature vectors. Alternatively or additionally, a machine learning engine may use clustering (also referred to as cluster analysis) to identify commonalities in the inputs. The machine learning engine may group (i.e., cluster) the inputs based on those commonalities. The machine learning engine may use hierarchical clustering, k-means clustering, and/or another clustering method or combination thereof. In an embodiment, a machine learning engine includes an artificial neural network. An artificial neural network includes multiple nodes (also referred to as artificial neurons) and edges between nodes. Edges may be associated with corresponding weights that represent the strengths of connections between nodes, which the machine learning engine adjusts as machine learning proceeds. Alternatively or additionally, a machine learning engine may include a support vector machine. A support vector machine represents inputs as vectors. The machine learning engine may label, classify, and/or categorizes inputs based on the vectors. Alternatively or additionally, the machine learning engine may use a naïve Bayes classifier to label, classify, and/or categorize inputs. Alternatively or additionally, given a particular input, a machine learning model may apply a decision tree to predict an output for the given input. Alternatively or additionally, a machine learning engine may apply fuzzy logic in situations where labeling, classifying, and/or categorizing an input among a fixed set of mutually exclusive options is impossible or impractical. The aforementioned machine learning model and techniques are discussed for exemplary purposes only and should not be construed as limiting one or more embodiments.

For example, the machine learning engine may receive, as inputs, user characteristic information associated with a contractor (e.g., contractor bid data and contractor legacy data) and job characteristic information associated with a job. The machine learning engine may associate one or more candidate contractors with the job characteristic information. Alternatively or additionally, the machine learning engine may associate one or more candidate jobs with the input user characteristics.

In an embodiment, as a machine learning engine applies different inputs to a machine learning model, the corresponding outputs are not always accurate. As an example, the machine learning engine may use supervised learning to train a machine learning model. After training the machine learning model, if a subsequent input is identical to an input that was included in labeled training data and the output is identical to the supervisory signal in the training data, then output is certain to be accurate. If an input is different from inputs that were included in labeled training data, then the machine learning engine may generate a corresponding output that is inaccurate or of uncertain accuracy. In addition to producing a particular output for a given input, the machine learning engine may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In some embodiments, the AI engine 355 may be in a configured to generate one or more learned contractor profiles. The AI engine 355 may be trained by:
a. receiving data from the input module 202, the data relating to a plurality of contractors,
b. correlating and/or detecting patterns in the data,
c. grouping the data into distinct (discrete) classifications in accordance with the correlated patterns,
d. generating a plurality of contractor profiles in sync with the classifications, each of the plurality of contractor profiles comprising:
   i. a range of weighted factor correlating to classifications,
   ii. predicted, data, preferences and behavior of an associated contractor, and
e. responsive to receiving additional data from the input module 202, adjusting one or more of the plurality of contractor profiles.

In further embodiments, the AI engine 355 may be further used in a second way to generate one or more recommendations of one or more of the plurality of work opportunities 302. The generation of one or more recommendations may occur via one or more of the following steps:
a. associating the at least a portion of data received and/or inputted, by the contractor 160, via the input module 204 and the contractor legacy data with one or more learned contractor profiles, and
b. establishing one or more parameters for assessing the plurality of work opportunities, the one or more parameters comprising:
   i. a minimum correlation between the one or more learned contractor profiles and each of the plurality of work opportunities 302, and
   ii. a predetermined range of association of the weighted factors with each of the plurality of work opportunities 302,
c. analyzing each of the plurality of work opportunities 302 in accordance with the one or more parameters, and
d. generating the recommendation of one or more of the plurality of work opportunities.

In other embodiments, the contractor 160 may or may not use any of the aforementioned steps and perform a manual search for one or more of a plurality of work opportunities 302.

In further embodiments, the work opportunity module 300 may comprise an internal cost estimate engine 322. The internal cost estimate engine 322 may be used to calculate and/or estimate cost(s) of the one or more work opportunities 302. In some embodiments, the cost estimate engine 322 may comprise a searchable functionality of one or more data points relating to supplies, resources, and/or services (e.g., brand, manufacturer) relating to the one or more work opportunities 302. In some embodiments, selecting and/or indicating the one or more data points may cause an automatic integration of at least a portion of the one or more data points (e.g., name, price, unit of measurement) into the estimated cost of the one or more work opportunities 302. The one or more data points may be stored in a local and/or external database. In some embodiments, materials, resources, and/or products may be selected from an internal marketplace in communication with the work opportunity module 300. In further embodiments, the one or more data points may be configurable to be adjusted, modified, and/or updated in response to receiving an indication of a status change relating to the one or more data points. Responsive to the adjustment, modification, and/or update to the one or more data points, the corresponding selected data points selected for the cost estimate relating to the one or more work opportunities 200 may be adjusted accordingly. The changes/updates may come directly from the seller or manufacturer. Updates to the seller/manufacture product listing on the marketplace can be automatically reflected in project management workflows (e.g., without need for user interaction).

In some embodiments, the internal cost estimate option may allow a user (e.g., a developer creating the work opportunity) to estimate a total cost associated with the work opportunity. The estimate may include line items for each resource used in the work opportunity. In embodiments, each of the line items associated with the resources may include a specified resource and a specified quantity. In embodiments, the estimate may include one or more line items for labor required to complete the opportunity. Resources (e.g., materials, labor, products, etc.) can be added to the internal estimate from a marketplace (e.g., an internal marketplace and/or an external marketplace), the data associated with that resource can be used to easily provide information such as unit cost, total cost, lead time, specifications, unit of measurement, etc. for the estimate.

In some embodiments, the user may opt to allow preselected contractors and/or a preselected amount of contractors to bid on each of the one or more opportunities 302. In other embodiments, the user may opt to allow an unlimited and/or unrestricted number of contractors to bid on each of the one or more opportunities 302. In some embodiments, the work opportunity module 300 may generate one or more recommended contractors based on at least a portion of the information and/or data provided by the user (e.g., the location, the qualifications, etc.). The aforementioned contractors may be found via the marketplace module 500.

In further embodiments, the work opportunity module 300 may provide a user interface (UI) displaying (finished, pending, and/or current) one or more work opportunities 302.

In some embodiments, at least a portion of the data associated with the work opportunity module 300 and/or the one or more work opportunities 302 used, stored, and/or utilized to be searched and/or located in the marketplace module 500.

C. Bidding Module 400

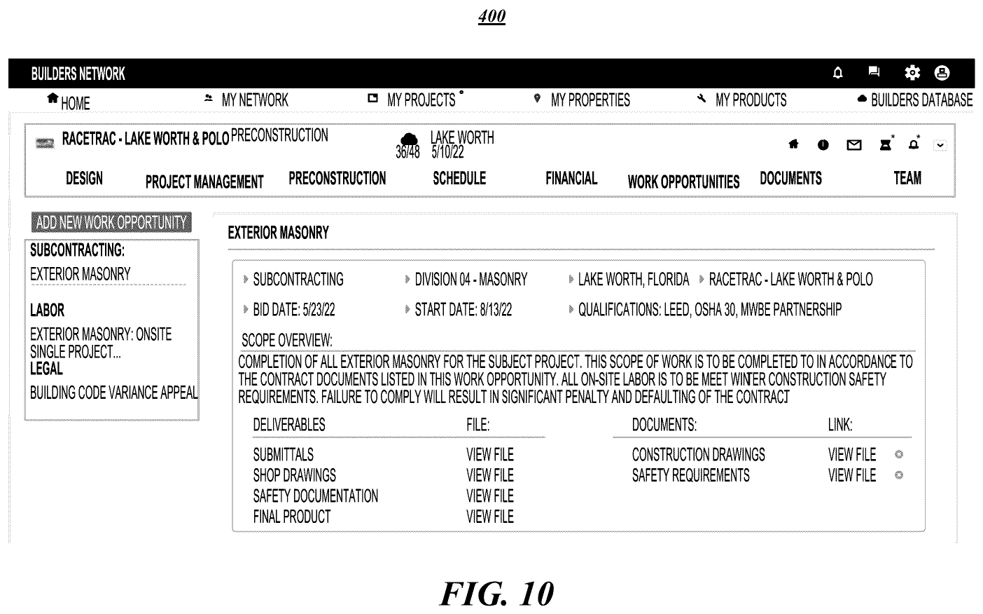

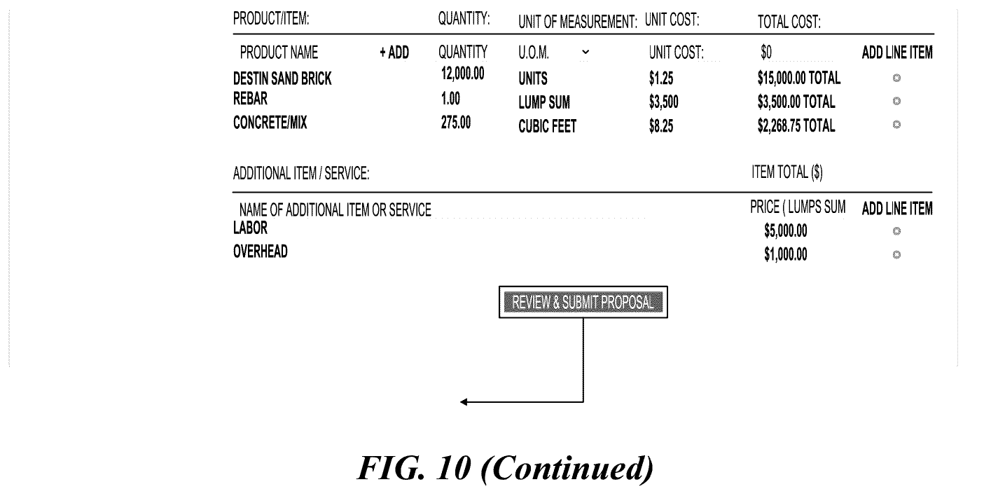

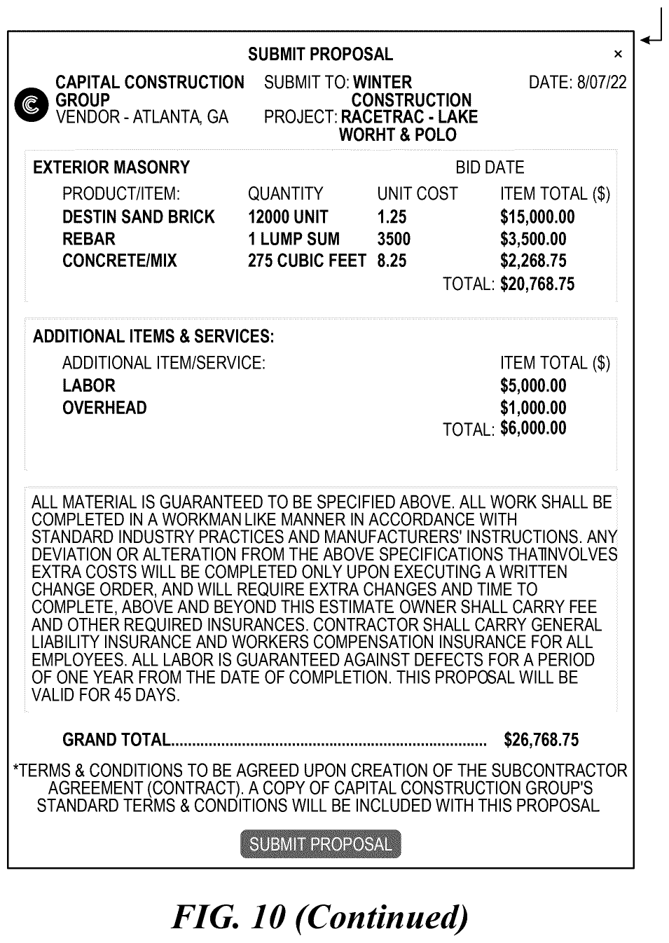

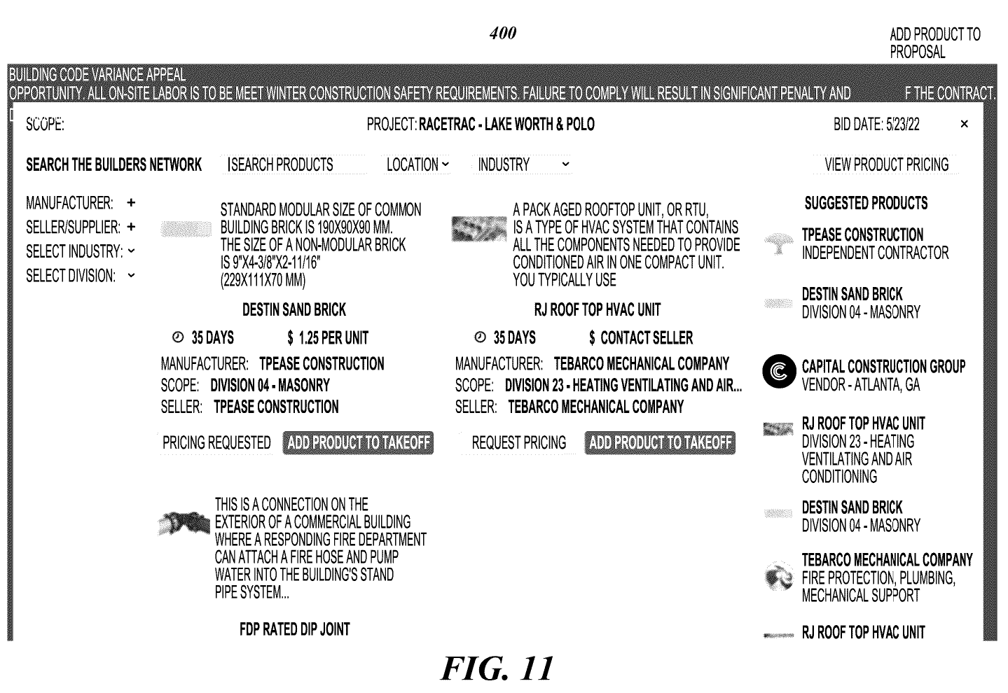

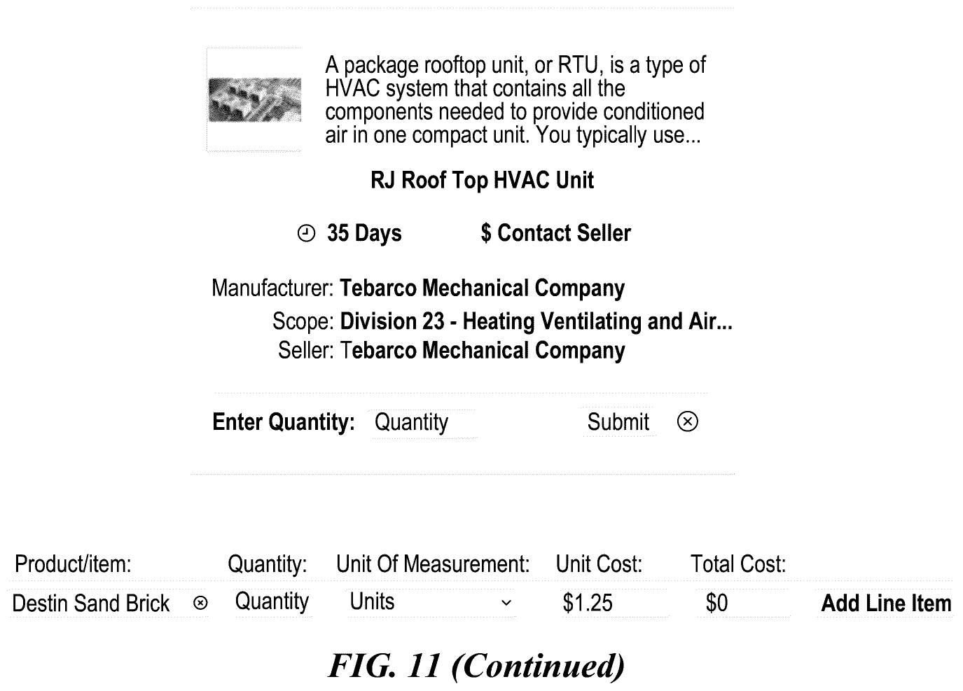

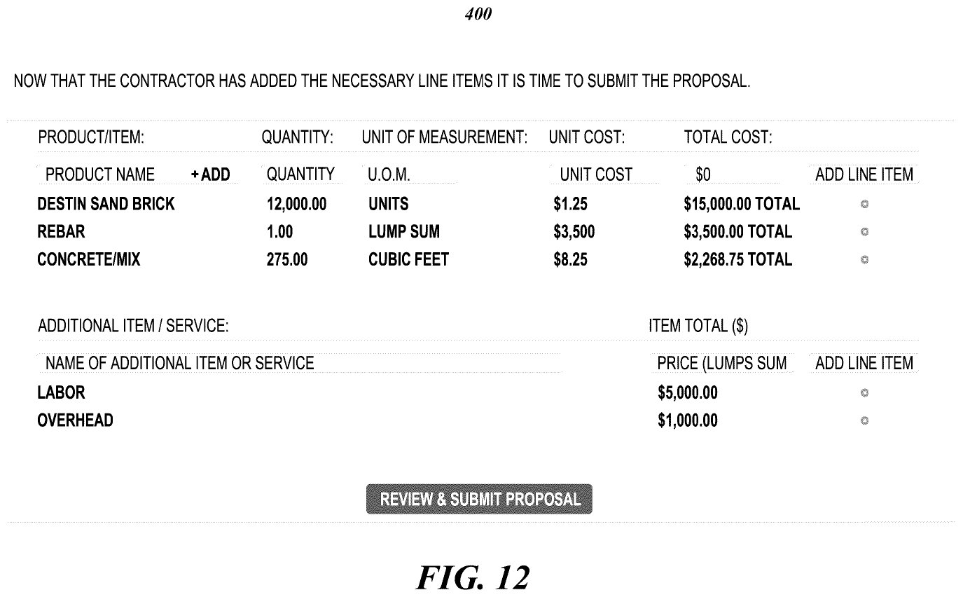

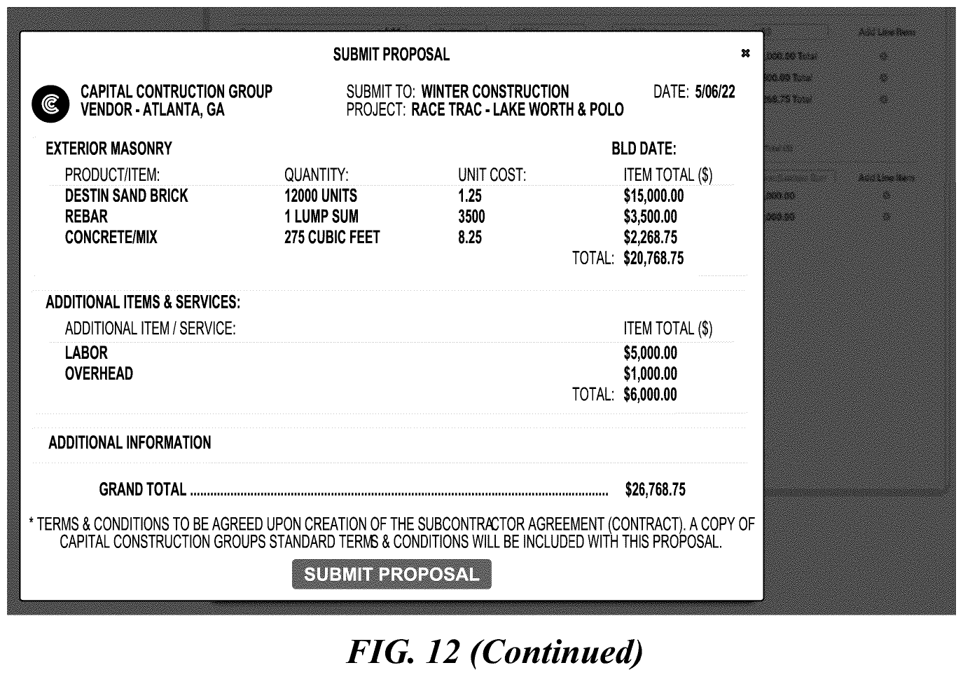

FIGS. 1-2 and 10-12 illustrates the bidding module 400 consistent with an embodiment of the present disclosure. The bidding module 400 comprises hardware and/or software that may be used (e.g., by the contractor 160) to create a bid (application for and/or proposal) 402 for one or more of the plurality of work opportunities 302.

Responsive to a selection of the one or more opportunities, a bid 402 may be generated (by the contractor) via the bidding module 400 for submission to the one or more work opportunities 302.

In some embodiments, the bidding module 400 may comprise a plurality of line items 404. The plurality of line items 404 may be used to incorporate data relating to a plurality of products 406 used for the bid 402. In some embodiments, the plurality of line items may make available to the contractor 160 to specify (and/or input) one or more of a product name, a quantity, of product, and a unit of measurement of each of the plurality of products 406.

For each of the plurality of products 406, the plurality of line items 404 may make available to the contractor 160, one or more of the following:
a. manufacturer,
b. scope,
c. lead time,
d. unit cost,
e. unit size,
f. shipping location,
g. seller specification,
h. manufacturer specification,
i. specifications, and
j. CSI division and/or scope.

Responsive to the specification of one or more of the plurality of products 406 by the contractor 160, a unit cost and/or total cost may populate in the line item 404. The data related to the resources (e.g., the line items 404) may be retrieved and/or selected from a marketplace module 500.

In further embodiments one or more of the plurality of line items 404 may be configured to receive an input of labor, tangential, and/or auxiliary costs.

In further embodiments additional customized information (e.g., information provided by the contractor) may be inputted and/or integrated into the bid 402.

Responsive to an indication of a completion of data entry, by the contractor 160, of the plurality of line items, the bid 402 may be generated and may include incorporating and/or integrating at least a portion of the plurality of line items 404 and/or the customized information.

Responsive to an acceptance, by a builder, of the bid 402, at least a portion of the bid 402 may be integrated into a contract 410 relating to one or more of the plurality of work opportunities 302.

D. Marketplace Module 500

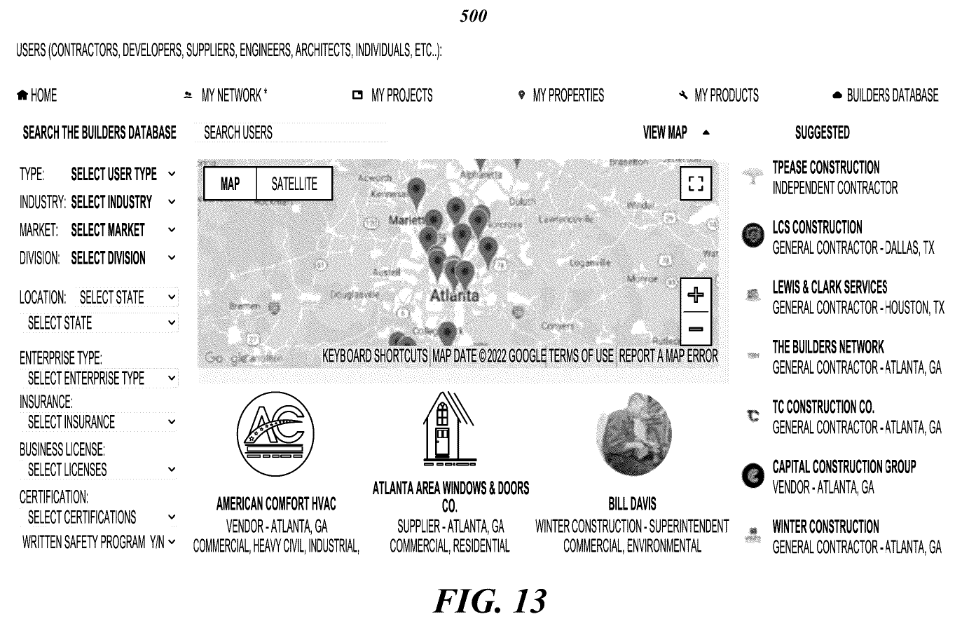

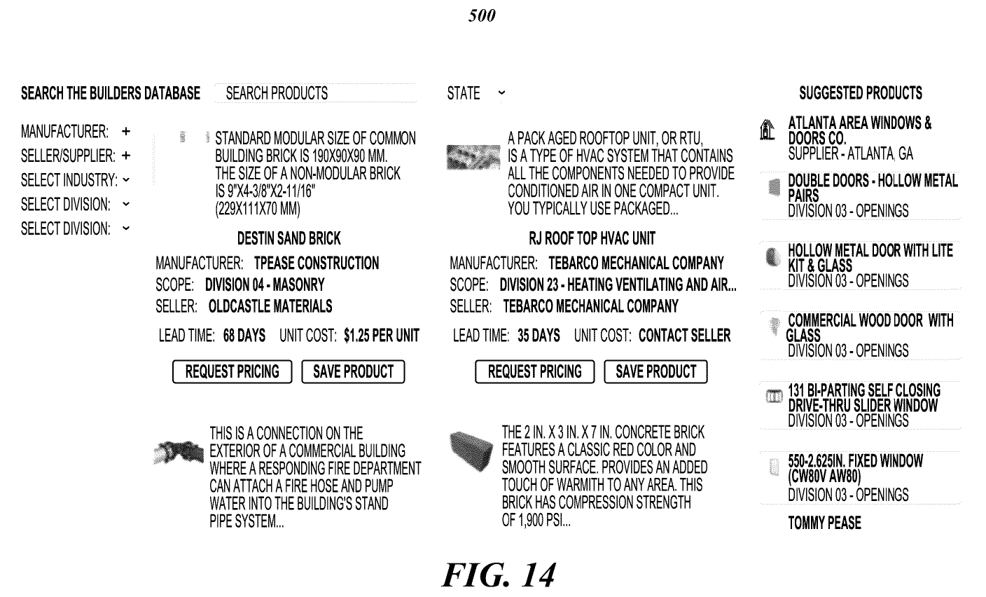

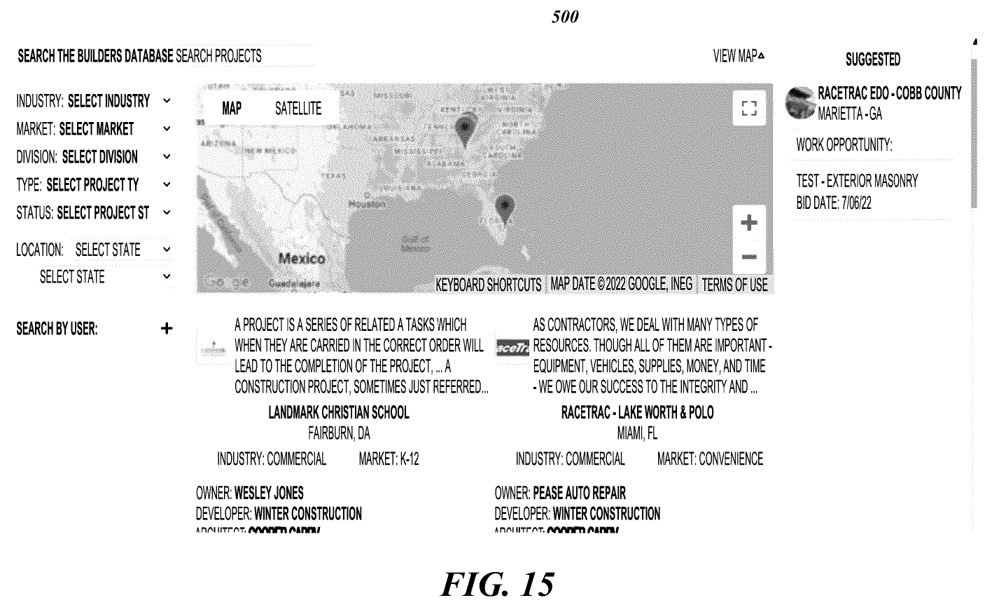

FIGS. 1-2 and 13-15 illustrate the marketplace module 500, consistent with embodiments of the present disclosure. The marketplace module 500 comprises hardware and/or software that may facilitate connection and/or communication of the contractor(s) and the general contractor(s) to a database of materials or resources available for purchase and use in various projects.

The marketplace module 500 may be further used as a means for a contractor to search for the one or more work opportunities 302 and/or for a general contractor to search for one more contractors for the one or more work opportunities 302. The searchability of the one or more opportunities 302 in the marketplace 500 may be facilitated via keywords or characteristics relating to the one or more work opportunities 302. By way of nonlimiting example, the searchability may be embodied as a contractor utilizing a search feature and filtering work opportunities by requiring each work opportunity to have the following:
a. Division Specification 306 (e.g., division 04—Masonry),
b. Scope Overview 316 (e.g., a scope of Retail), and
c. Location specification 314 (e.g., a location of Atlanta, GA).

In some embodiments, the marketplace module 500 may facilitate data access of the one or more work opportunities 302 by the contractor. By way of nonlimiting example, the data access may be embodied as information relating to an architect, photos, and/or overall project size associated with the one or more work opportunities 302.

In further embodiments, the marketplace module 500 may be embodied as a database having a plurality of goods and services made available by other users on the platform 100.

E. Contract Module 600

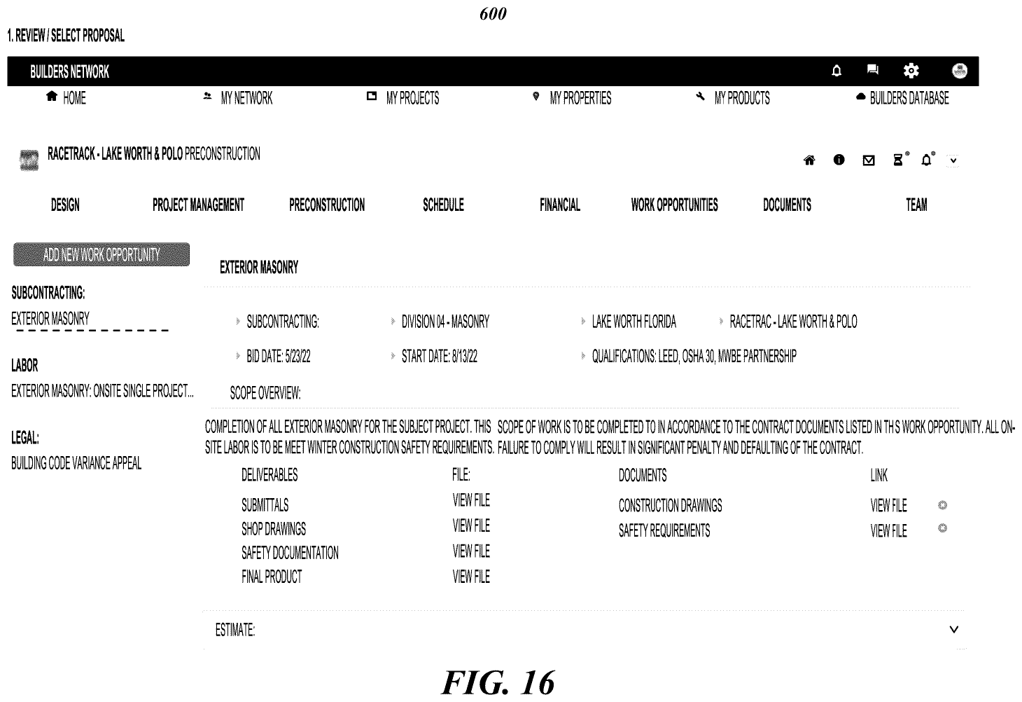

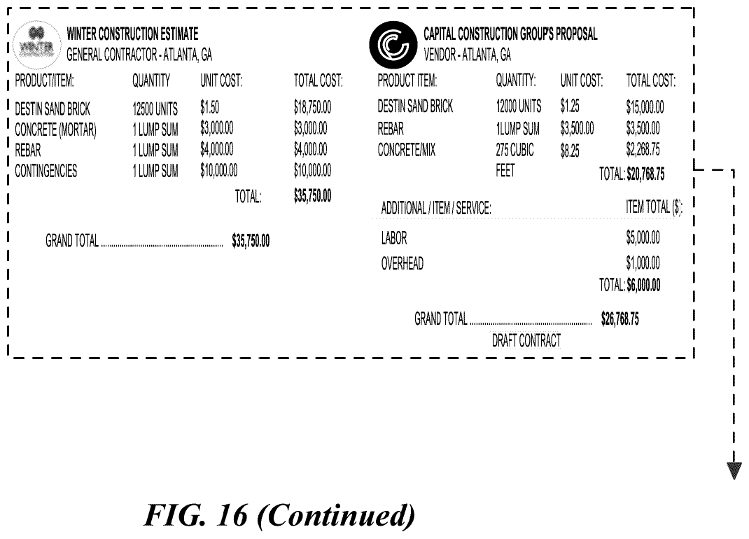

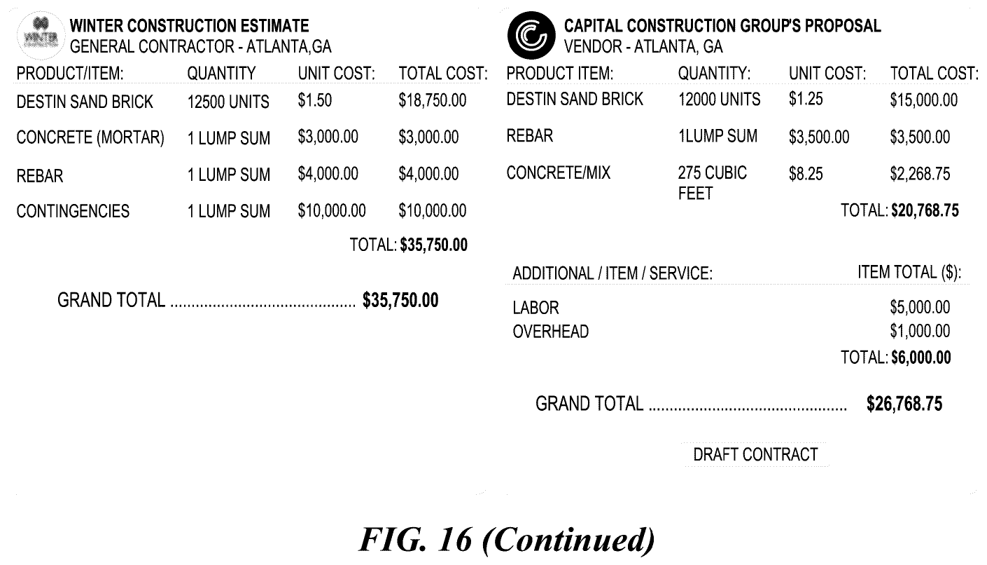

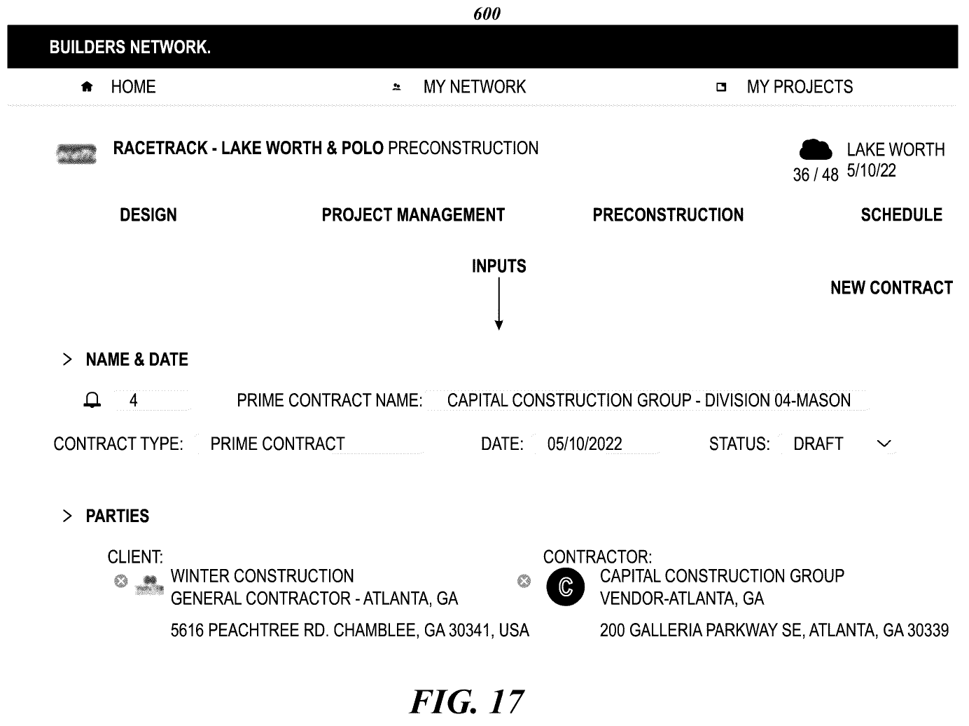

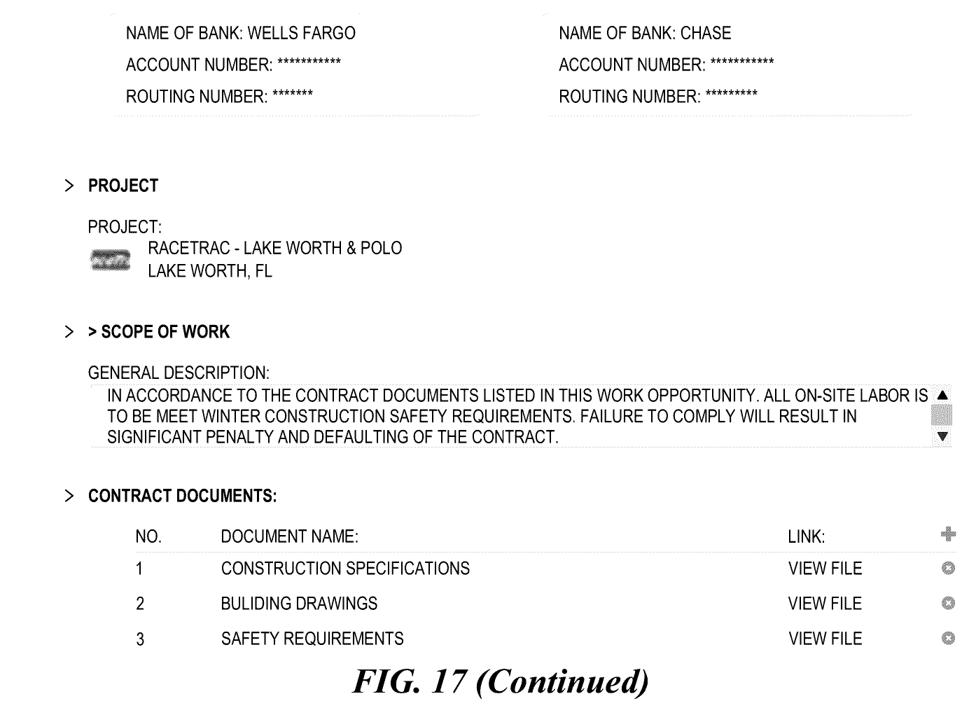

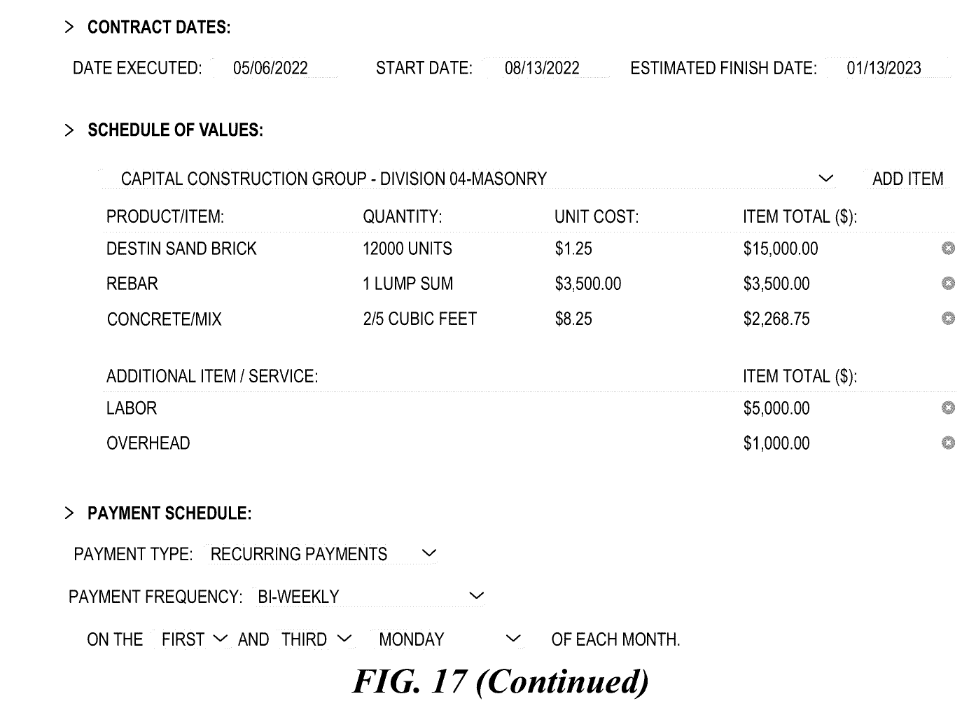

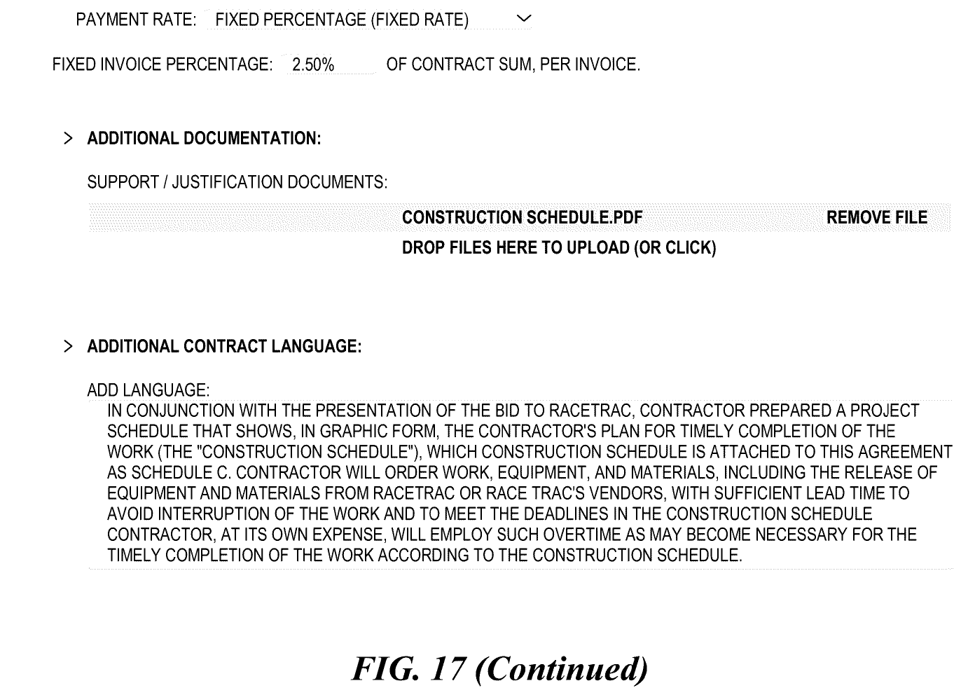

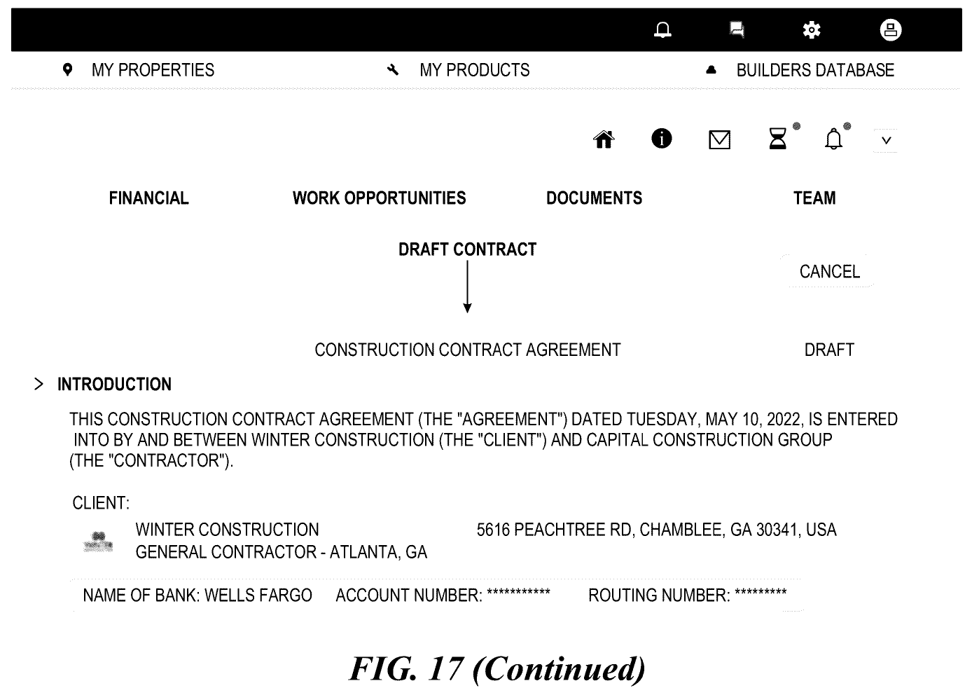

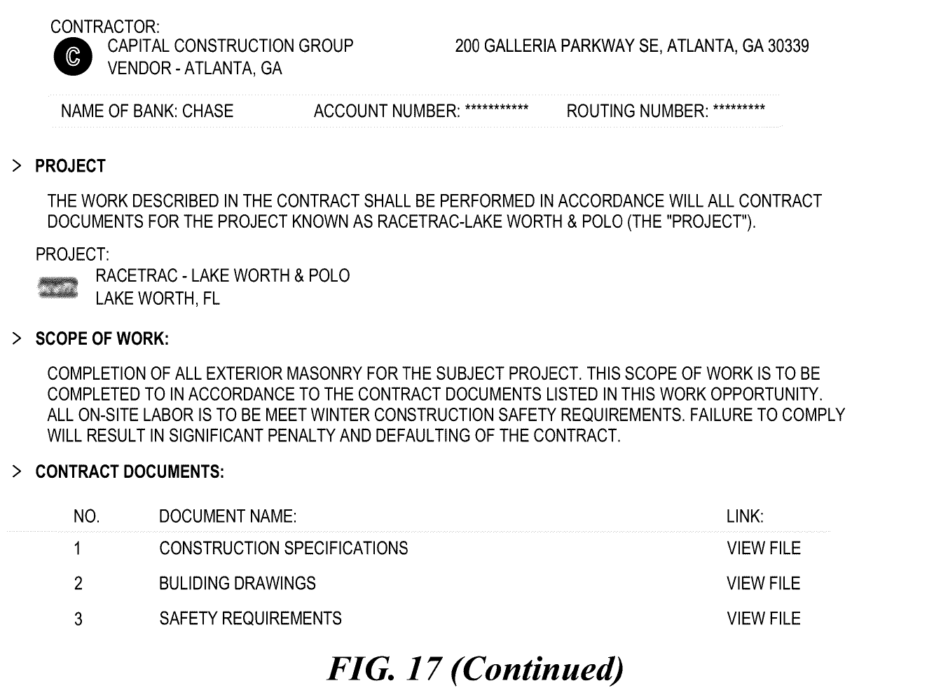

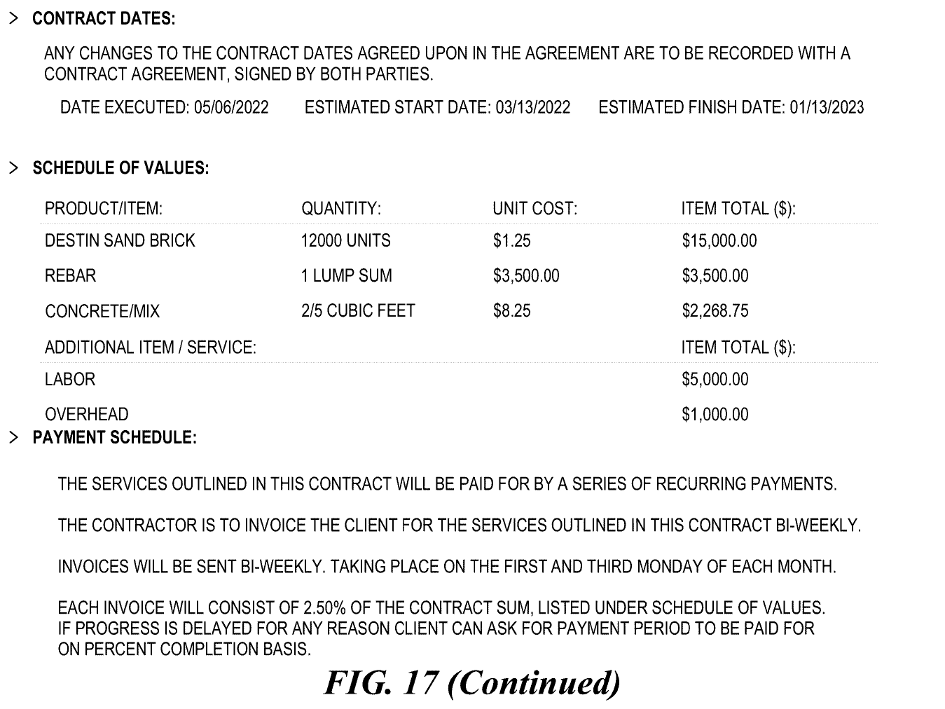

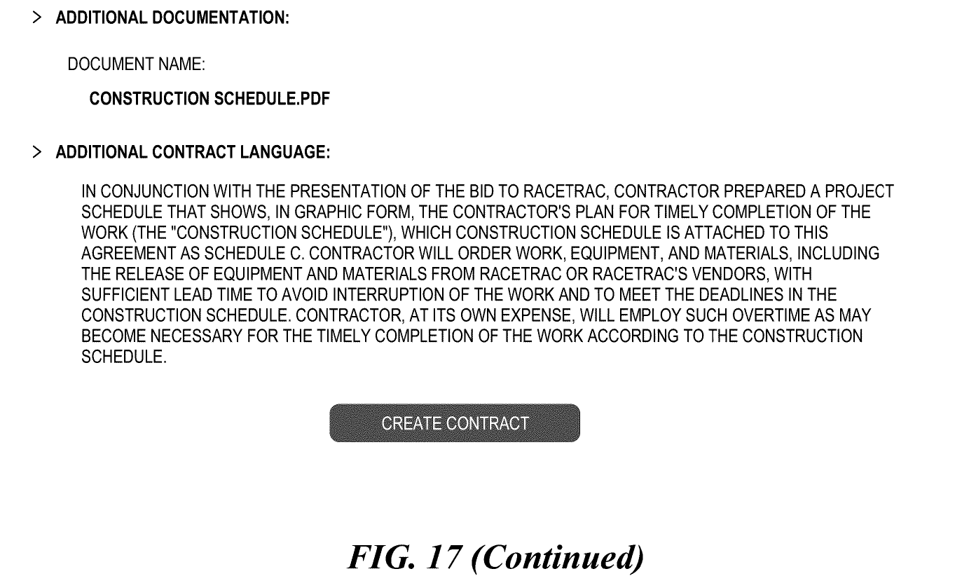

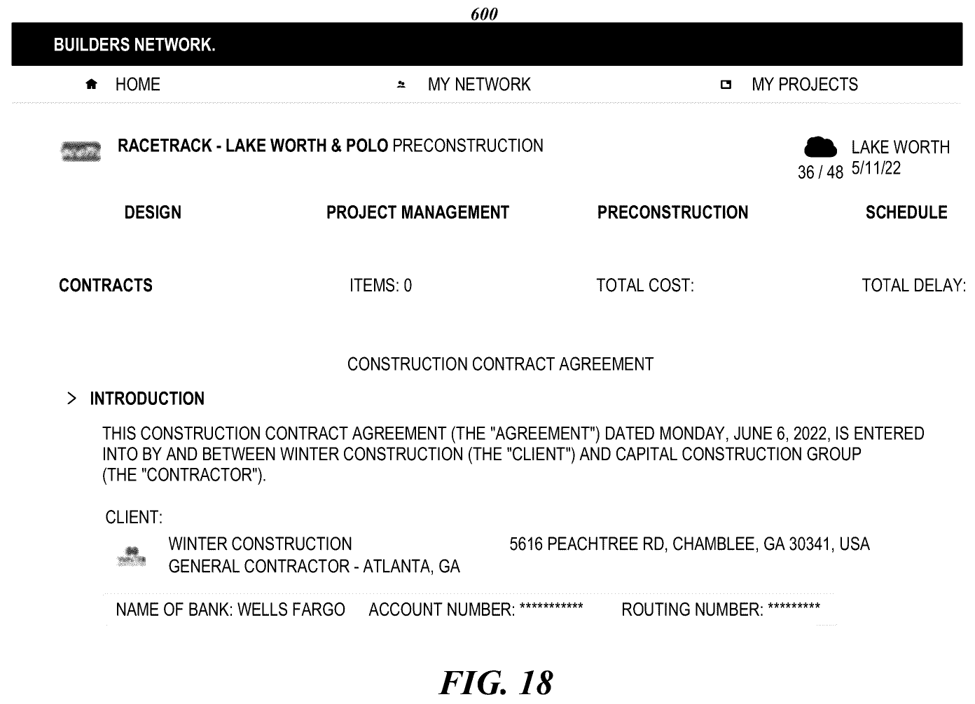

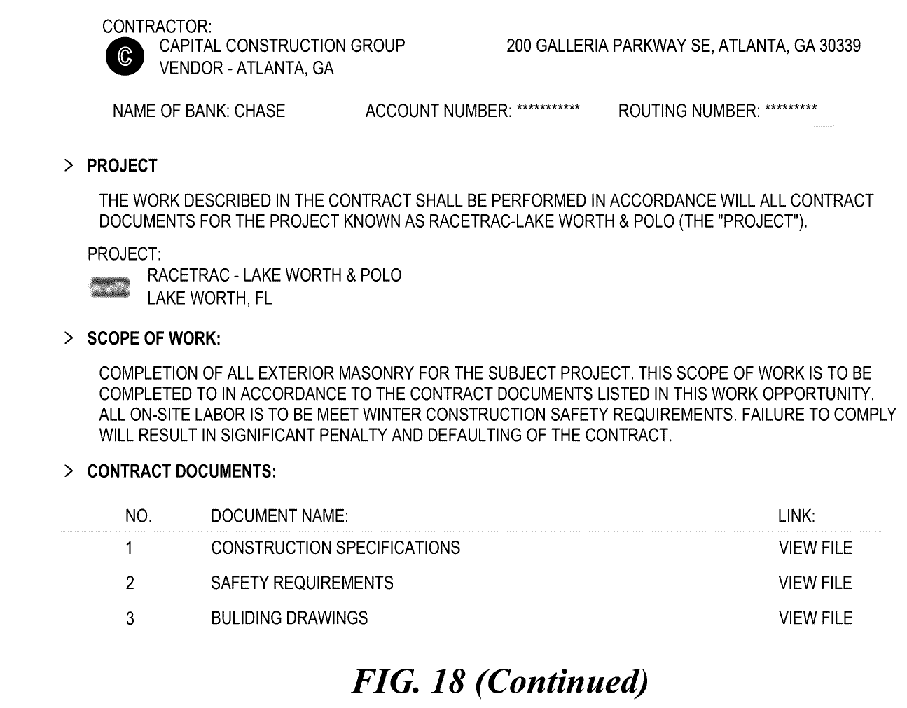

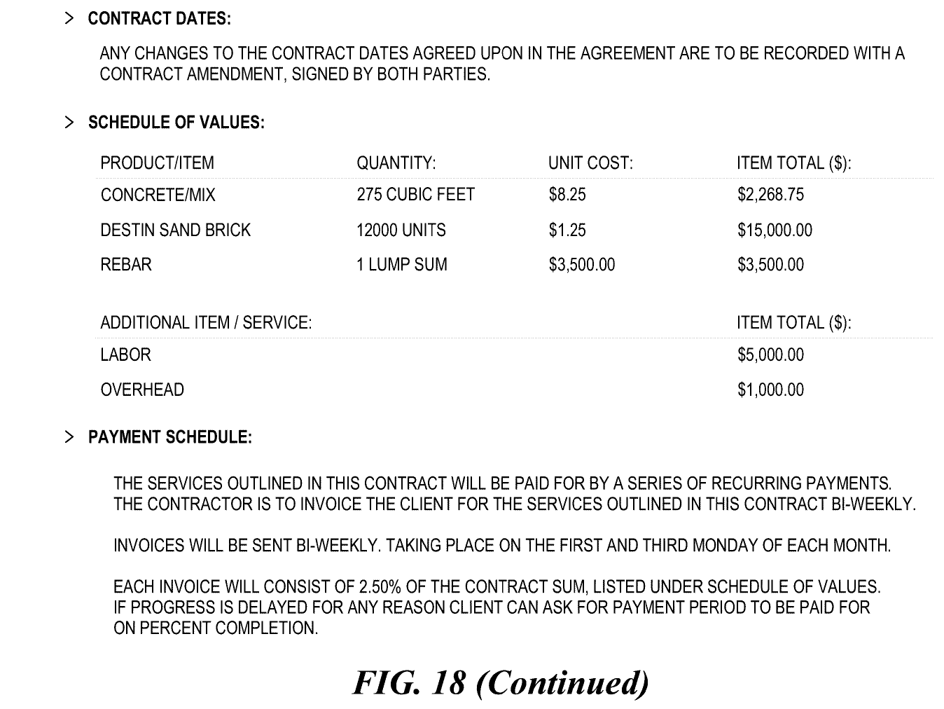

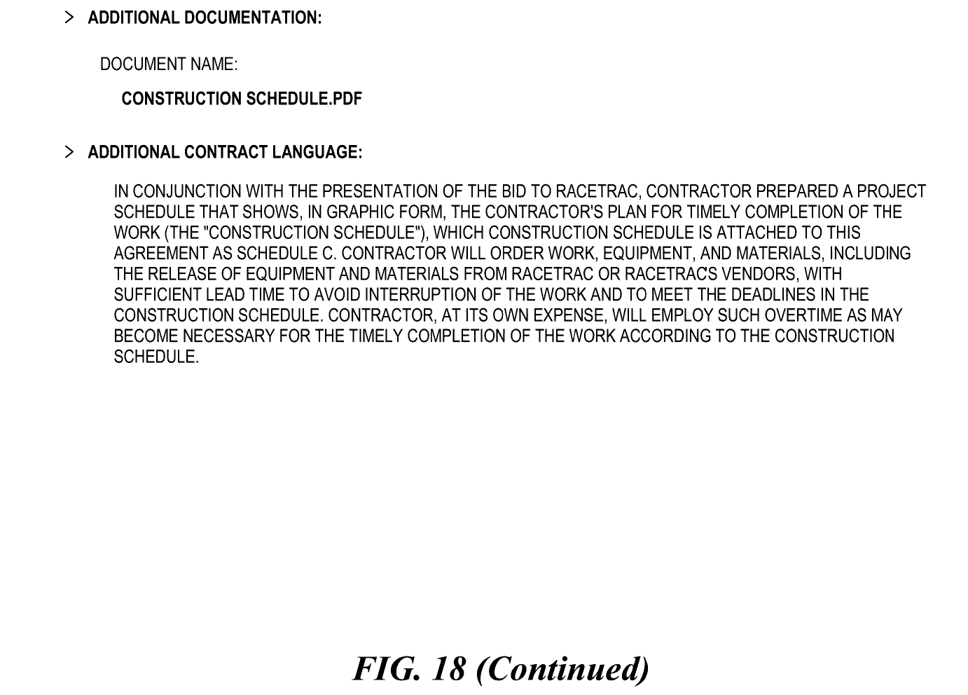

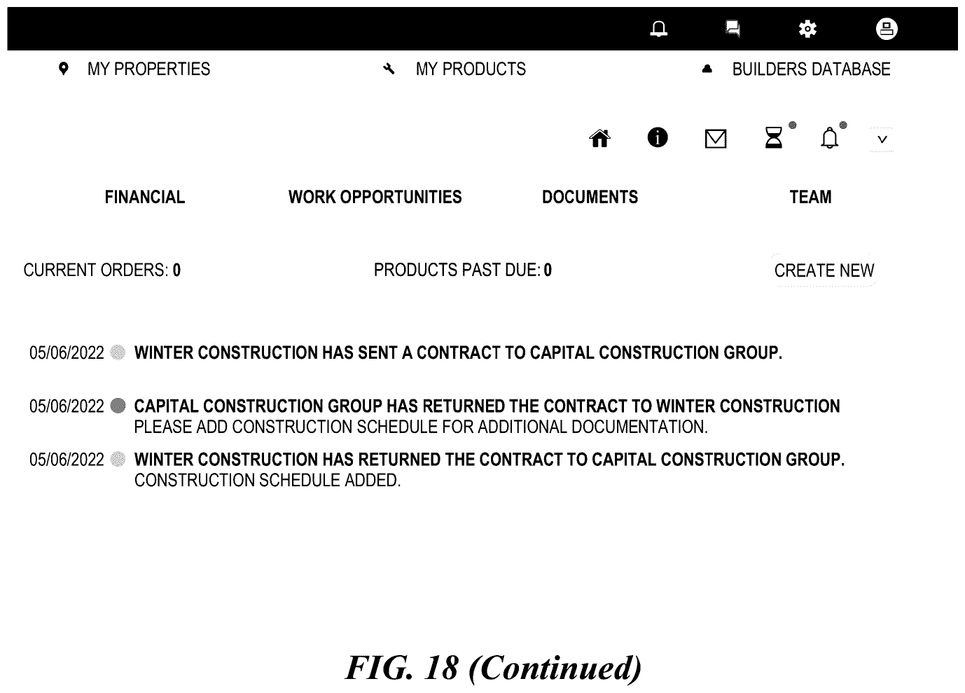

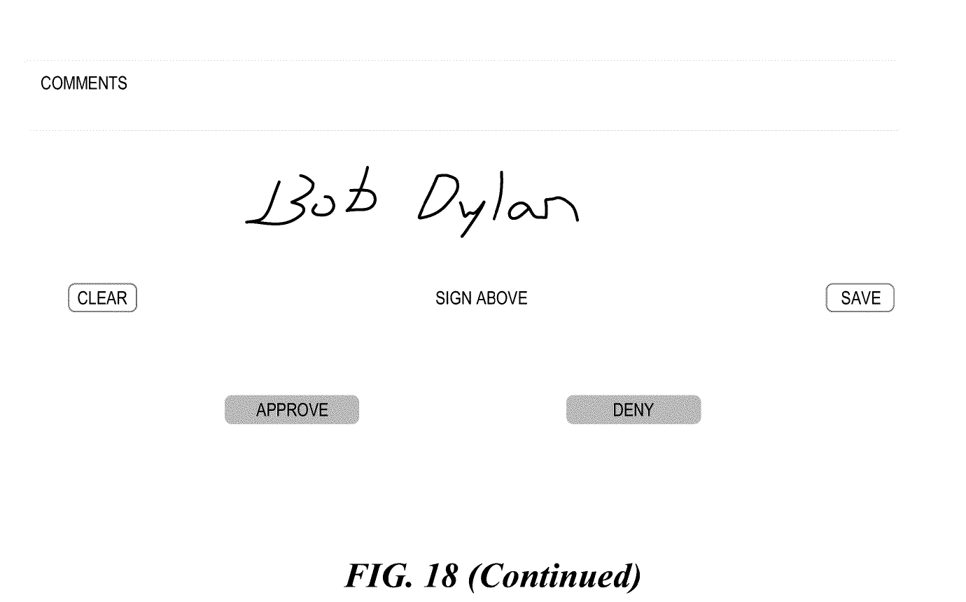

In some aspects, the platform 100 may include a contract module 600. As shown in FIGS. 1-2 and 16-18, the contract module 600 comprises hardware and/or software that may be used to, responsive to a selection and/or assignment of one of the bids and/or proposals of the one or more work opportunities 302, create a contract (and/or agreement) 602 relating to the one or more work opportunities 302 and/or project(s) 150.

In some embodiments, the contract creation module 600 may integrate at least a portion of the elements from the one or more work opportunities 302, and/or from the selected bid 352 into the terms of the contract. For example, the contract creation module 600 may receive User Data (e.g., name, demographic and/or biographic information, banking information, etc.) and/or Project Data for integration into the contract from the work opportunities 302 and/or the selected bid 352.

In further embodiments, the contract module 600 may comprise an electronic signature feature 604 configured to allow the subcontractor and/or the user to electronically verify and/or sign the contract 602.

In some embodiments, responsive to both (and/or multiple) parties signing the contract 602, a payment process (alternatively, “payment system”) 606 may be initiated. The payment process 606 may be configured to derive a payment schedule from various terms of the contract 602 and may facilitate payment (whether lump sum, or in predetermined portions/increments) from one user (e.g., the developer), to another user (e.g., the subcontractor). One nonlimiting example of the payment process 606 may be a Plaid™ Application Programming Interface (API) integration. In some embodiments the payment may pass directly from one party of the contract to the other. Alternatively or additionally, a third party (e.g., the platform 100) may collect one or more payments from one party and provide the one or more payments to another party. The payment schedule and/or facilitation may be derived from, one or more of the following:
a. At least a portion of the contract 602, (e.g., a contract clause specifying payment frequency, amount, dates, and/or the like),
b. banking and/or payment information from the user and/or the subcontractor,
c. method(s) of payment, and
d. incremental completion requirement(s).

In further embodiments, the contract module 600 may be configured to transmit at least a portion of aspects and/or data related to the contract 602 to the workflow module 700.

At least a portion of the aforementioned process occurring in the contract module 600 between the user and the subcontractor may be used for creation and execution of a prime contract and/or creation of a (resources) purchase order.

F. Workflow Module 700

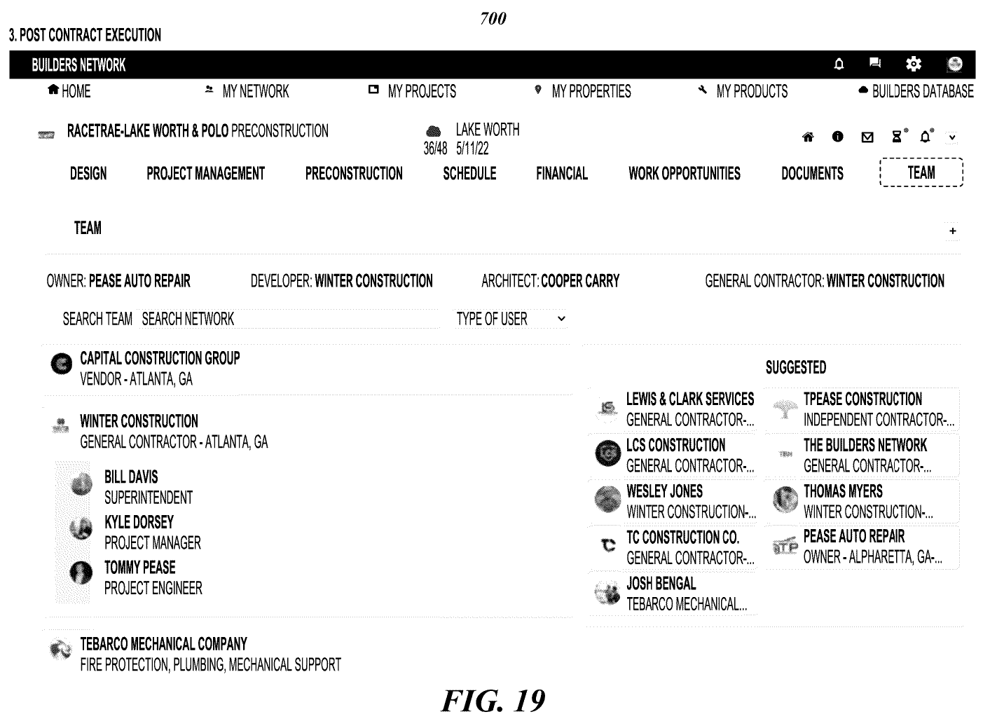

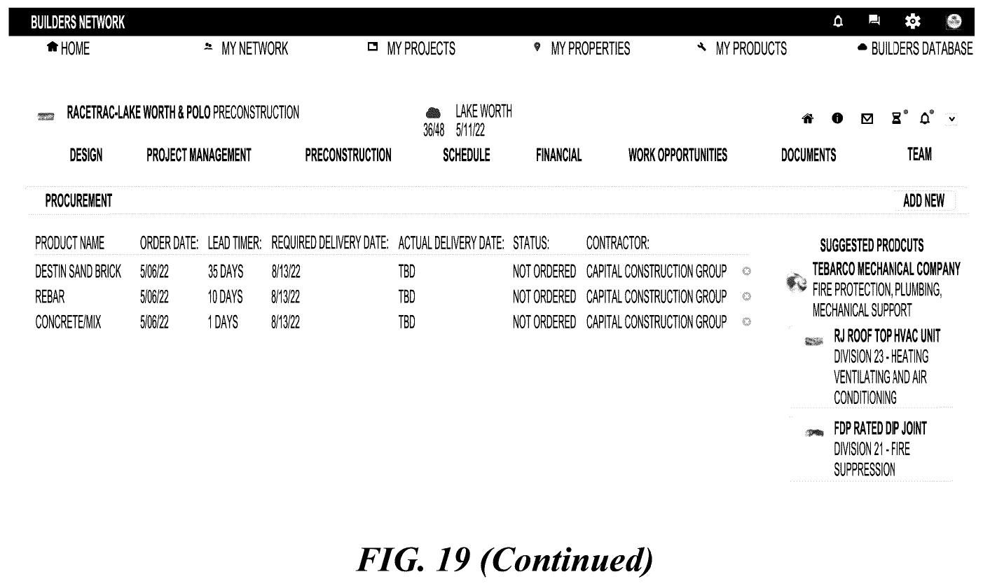

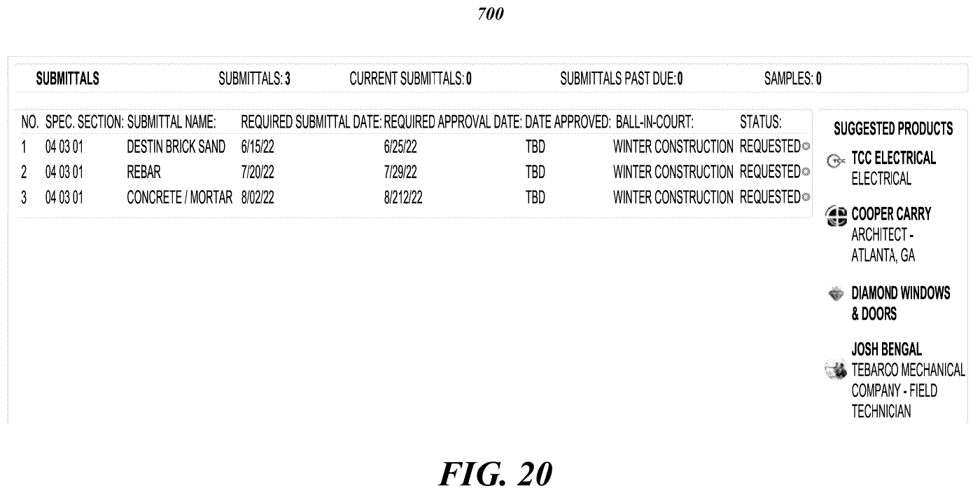

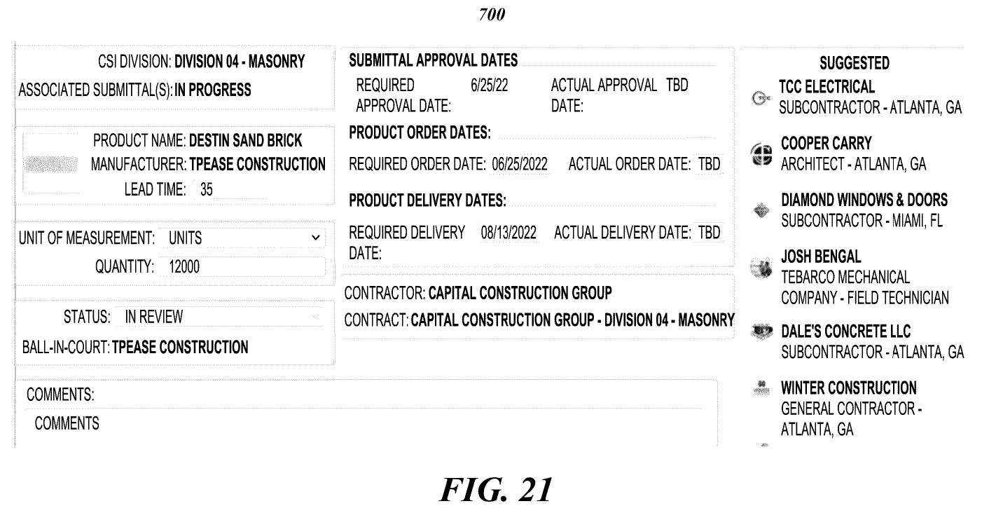

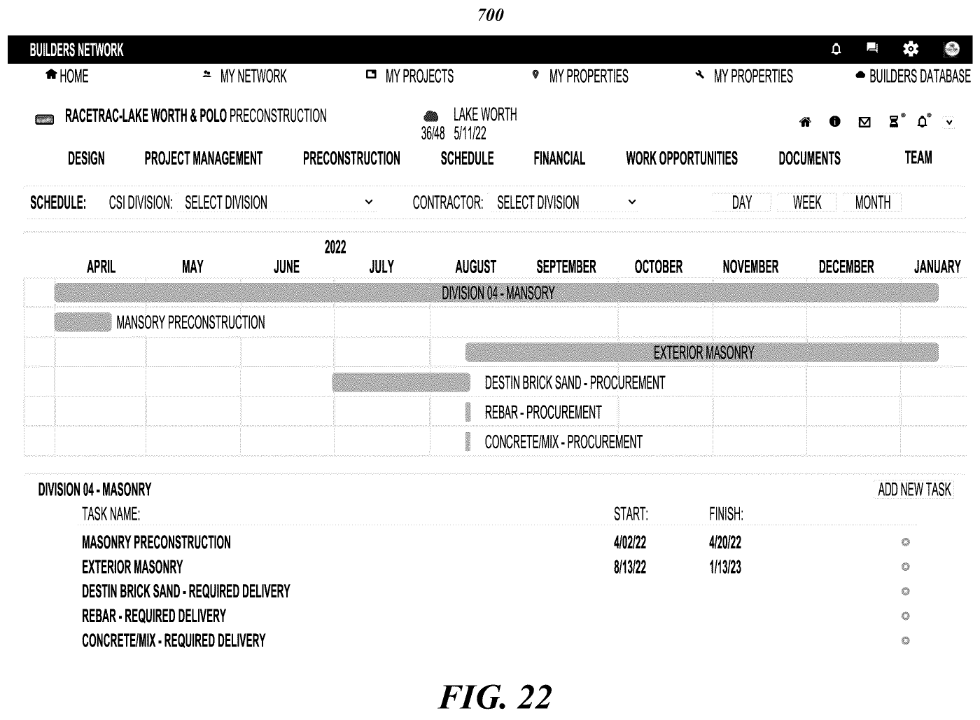

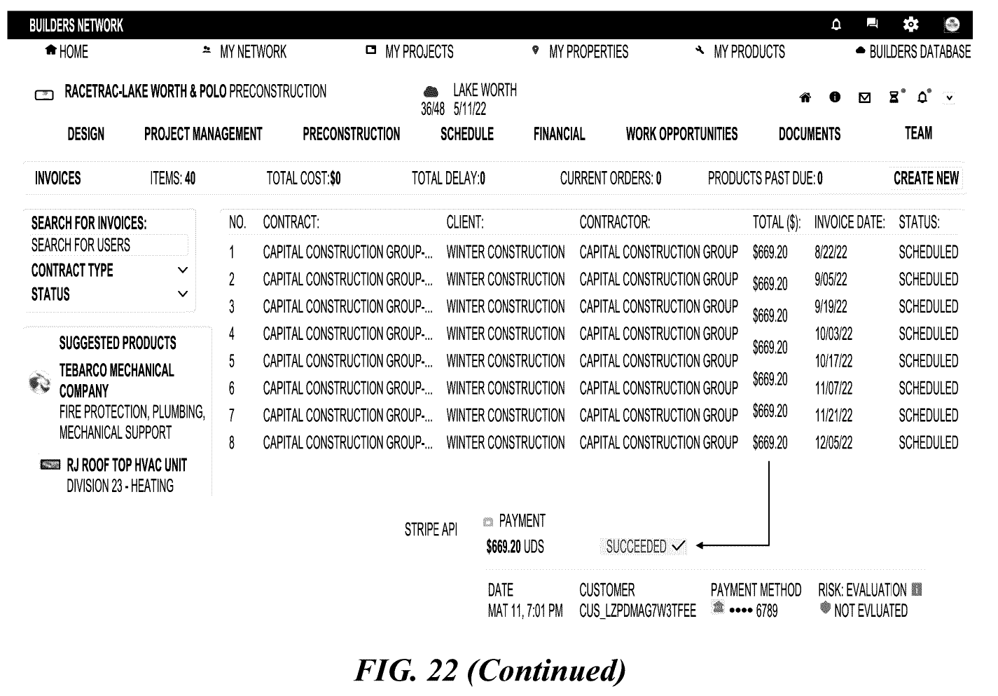

In some embodiments, the platform 100 may include a workflow module 700. As shown in FIGS. 1-2 and 19-22. the workflow module 700 may be used, by the user, to automate, track, monitor, and/or interact with aspects of the project 150. The workflow module 700 may be further used to integrate at least a portion of the resultant data from the contract module 600 and/or the work opportunity module 300.

In some embodiments, the workflow module 700 may be configured to receive at least a portion of data from the contract module 600, the work opportunity module 300, one or more other modules, one or more internal databases, and/or one or more external databases. In at least some embodiments, resources and/or data may be retrieved from the marketplace module 500.

In further embodiments, the workflow module 700 may process (e.g., parse, and/or match) the received data via relating, comparing and/or associating each of the received data with one another. The processed data may be used to organize the project 150 in systemic and/or chronological order, also known as a workflow 710. The workflow 710 may be embodied as, but not limited to, a visual interface and/or display of a systematic organization of resources, activities, and/or tasks turned into processes that transform resources, provide services, and/or process information. These items that are automated may be referred to as “project management workflows”.

The workflow 710 may be configured to (in predetermined temporal increments) receive updated information related to one or more of the received data. Receiving updated information related to one or more of the received data may be embodied as, and/or referred to, persistent data flow 720. In response to the workflow 710 receiving a new and/or modified data point via the persistent data flow 720, a modification in at least a portion of the workflow 710 may be prompted in accordance with the new and/or modified data point. Said modification in at least a portion of the workflow 710 may induce a modification and/or transformation in one or more other portions of the workflow 710 by virtue of dependency of the one or more other portions on the modified portion of the workflow.

In further embodiments, the workflow module 700 may comprise a timetable 730. The timetable 730 may be populated by at least a portion of aspects of the workflow 710. The timetable 730 may be used to visually integrate with and/or visually display at least a portion of the workflow 710. In some embodiments, the timetable 730 may be manually adjustable and/or customizable by the user. By way of nonlimiting example, the timetable 730 may be embodied as, for example, a schedule and/or calendar. Further, any document or project management workflow 710 where the updated resource is located may adjust accordingly.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components as found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method for Providing Curated Work Opportunities 1000

Consistent with embodiments of the present disclosure, a method for providing curated work opportunities 1000 may be performed by at least one of the aforementioned modules. The method 1000 may be embodied as, for example, but not limited to, computer instructions, which, when executed, perform the method. The method 1000 may comprise the following stages:
a. 1005—receiving contractor bid data from a contractor 160,
b. 1010—receiving a request, by the contractor, for a recommendation of one or more work opportunities from a plurality of work opportunities 302,
c. 1015—associating the contractor bid data and the contractor legacy data with one or more learned contractor profiles trained by an AI engine 355,
d. 1020—establishing one or more parameters for assessing the plurality of work opportunities in accordance with the associated contractor bid data,
e. 1025—analyzing each of the plurality of work opportunities in accordance with the one or more parameters, and
f. 1030—providing the contractor with the recommendation of one or more of the plurality of work opportunities.

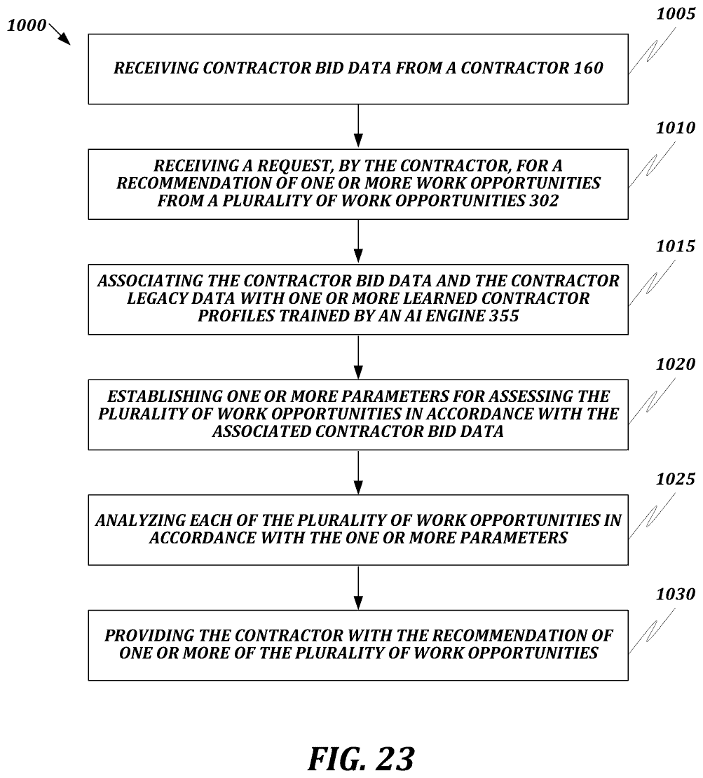

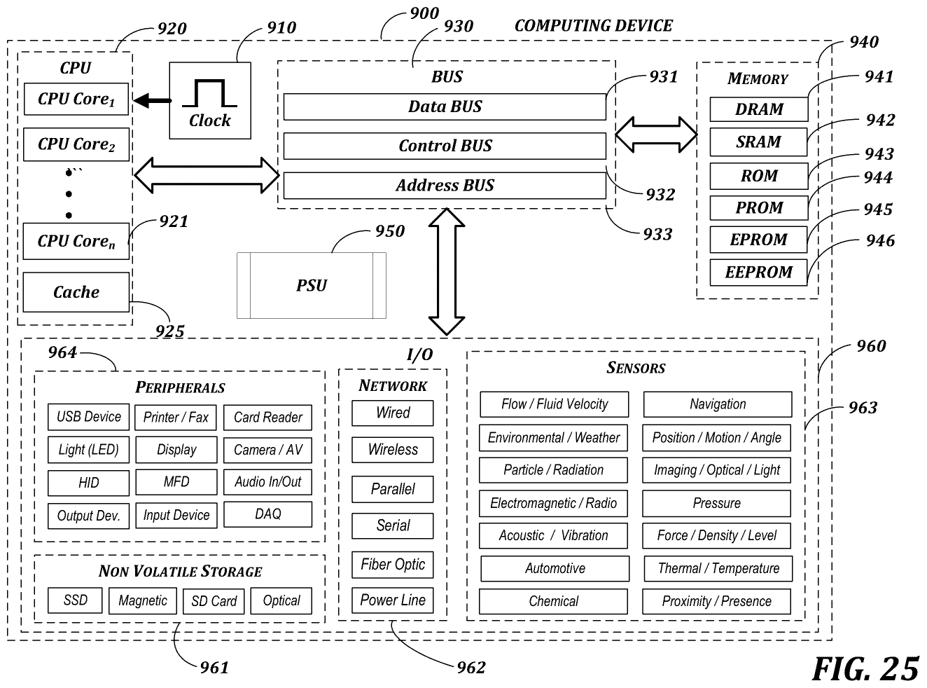

FIG. 23 is a flow chart setting forth the general stages involved in a method 1000 consistent with an embodiment of the disclosure for providing platform 100 and/or for persistent data flow. Method 1000 may be implemented using a computing device 900 or any other component associated with platform 100 as described in more detail below with respect to FIG. 25. For illustrative purposes alone, computing device 900 is described as one potential actor in the following stages.

Method 1000 may begin at starting block 1005: receiving contractor bid data from a contractor 160. The contractor bid data may be embodied as data currently selected, specified and/or associated with the contractor 160. The contractor bid data may comprise one or more of the following:
a. a CSI division,
b. a scope of work,
c. a service performed,
d. a geolocation,
e. an availability timeframe,
f. one or more resources to be used, and
g. supporting documentation.

Receiving contractor bid data from a contractor 160 may further comprise receiving contractor legacy data relating to past work opportunities, projects, and/or contracts associated with the contractor 160. The contractor legacy data may be embodied as work, one or more opportunities, and/or one or more projects previously completed by the contractor 160.

Method 1000 may then proceed to stage 1010: receiving a request, by the contractor 160, for a recommendation of one or more work opportunities from a plurality of candidate work opportunities (e.g., the work opportunities 302). Each of the plurality of candidate work opportunities may comprise one or more of the following:
a. one or more work types,
b. a CSI division,
c. a bid start date,
d. a start date,
e. one or more qualification requirements,
f. a geolocation,
g. an opportunity scope overview,
h. deliverables,
i. supporting documentation, and
j. an internal cost estimate.

Method 1000 may then proceed to stage 1015: associating the contractor bid data and the contractor legacy data with one or more learned contractor profiles trained by an AI engine 355. In another embodiment, stage 1015 may be embodied as associating the contractor bid data with a learned contractor profile trained with contractor legacy data relating to past work opportunities, projects, and/or contracts associated with the contractor, by an AI engine 355.

Method 1000 may then proceed to stage 1020: Establishing one or more parameters for assessing the plurality of candidate work opportunities. The one or more parameters may comprise a minimum correlation between the one or more learned contractor profiles and each of the plurality of candidate work opportunities. The one or more parameters may further comprise a predetermined range of association of weighted factors with each of the plurality of candidate work opportunities.

Method 1000 may then proceed to stage 1025: analyzing each of the plurality of work opportunities 302 in accordance with the one or more parameters. Based on the comparison of the parameters from the contractor bid data and/or the contractor legacy data with the plurality of candidate work opportunities 302, the AI engine may determine one or more work opportunities, of the plurality of candidate work opportunities 302 to recommend as a good fit for the contractor.

Method 1000 may then proceed to stage 1030: providing the contractor 160 with the recommendation of one or more of the plurality of work opportunities 302. In embodiments, providing the recommendation may include, for example, displaying the recommendation (e.g., in the work opportunity module), or otherwise providing the recommendation to the contractor. In some embodiments, providing the recommendation may include providing, to a user associated with one or more of the recommended work opportunities, contact information of the contractor.

B. Method for Operational Persistent Data Flow 2000

Consistent with embodiments of the present disclosure, a method for operational persistent data flow 2000 may be performed by at least one of the aforementioned modules. The method 2000 may be embodied as, for example, but not limited to, computer instructions, which, when executed, perform the method. The method 2000 may comprise the following stages:
a. 2005—building one or more work opportunities, each work opportunity including a plurality of specifications for a project,
b. 2010—for each of the one or more opportunities, receiving one or more proposals,
c. 2015—determining one or more proposals for each of the one or more opportunities,
d. 2020—for each of the one or more determined proposals, creating and executing a contract based off data from the proposal,
e. 2025—assembling a plurality of resources necessitated for the project,
f. 2030—for each of the plurality of resources, calculating resource data,
g. 2035—establishing a procurement schedule of the plurality of resources based at least in part on the calculated resource data,
h. 2040—establishing a project schedule based at least in part on the procurement schedule,
i. 2045—determining a payment schedule for plurality of resources outlined in contract,
j. 2050—receiving an indication of a change relating to one or more of the plurality of resources, and
k. 2055—responsive to receiving the indication of the change, updating at least a portion of the resource data.

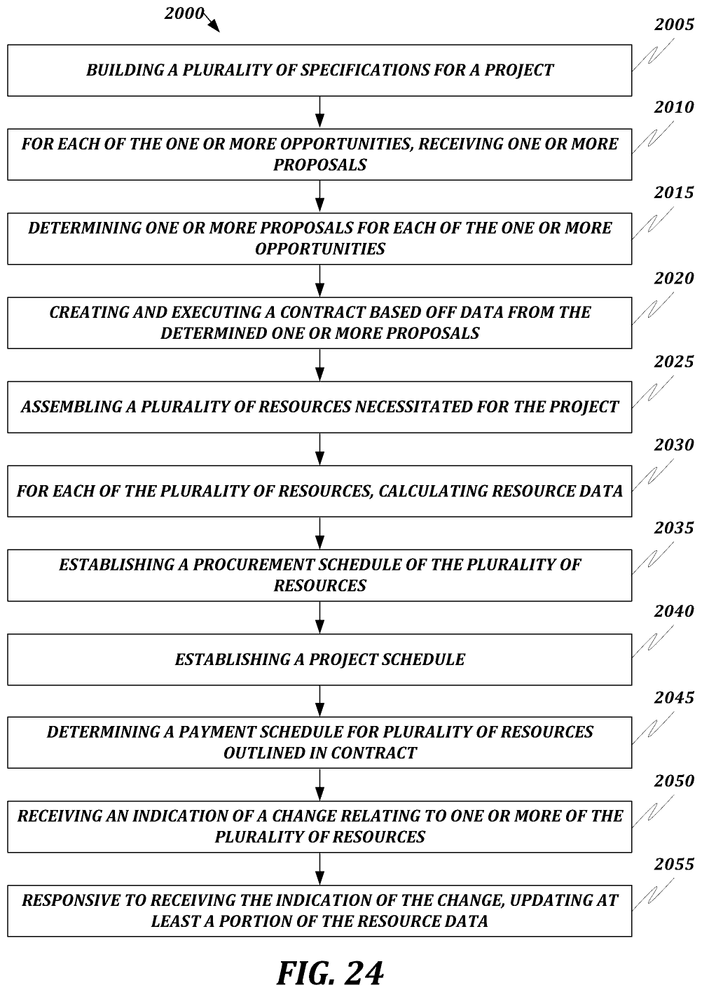

FIG. 24 is a flow chart setting forth the general stages involved in a method 2000 consistent with an embodiment of the disclosure for providing platform 100 and/or for persistent data flow. Method 2000 may be implemented using a computing device 900 or any other component associated with platform 100 as described in more detail below with respect to FIG. 25. For illustrative purposes alone, computing device 900 is described as one potential actor in the following stages.

Method 2000 may begin at starting block 2005: building a plurality of specifications for a project, the building comprising defining one or more work opportunities. In some embodiments the one or more work opportunities may be made available on a marketplace of an online platform. Each of each of the one or more opportunities may comprise one or more of the following:
a. one or more work types,
b. a CSI division,
c. a bid start date,
d. a start date,
e. one or more qualification requirements,
f. a geolocation,
g. an opportunity scope overview,
h. deliverables,
i. supporting documentation,
j. an internal cost estimate,
k. a parent project, and
l. one or more proposals received.

Method 2000 may then proceed to stage 2010: for each of the one or more opportunities, receiving one or more proposals. In some embodiments one or more (e.g., each) of the one or more proposals may include one or more of the following:
a. one or more resources to be used in completion of the work opportunity,
b. a proposed date for beginning the work opportunity,
c. a proposed date for completion of the work opportunity,
d. a cost for completion of the work opportunity,
e. information relating to each of one or more contractors submitting the bid, and
f. additional information regarding any key information pertaining to the proposal, as specified by the contractor.

In some embodiments, one or more of the plurality of resources may be accessible (and/or have data related to it accessible) via the marketplace. From a contractor view, one or more data points for each of the one or more work opportunities may be searchable in the marketplace.

Method 2000 may then proceed to stage 2015: determining (selecting and/or accepting) one or more proposals for each of the one or more opportunities.

Method 2000 may then proceed to stage 2020: creating and executing, for each of the one or more determined proposals, a contract based off data from the determined proposal.

Method 2000 may then proceed to stage 2025: assembling and/or aggregating, in accordance with each determined proposal and the plurality of specifications of the project, a plurality of resources necessitated for the project. For example, the resource identifier may be specified in one or more of the work opportunities and the proposal. Additionally, the resource quantities may be specified in one or more of the work opportunities and/or the proposal. The plurality of resources relating to the proposal may be aggregated and/or retrieved from a marketplace having information of one or more of the following:
a. the plurality of resources,
b. a manufacturer profile of each of the plurality of resources,
c. a contractor profile for each of the one or more contractors, and
d. a general contractor profile for each of one or more general contractors.

Method 2000 may then proceed to stage 2030: for each of the plurality of resources, determining (and/or calculating) resource data. The resource data may comprise, for one or more resource identifier specified in the plurality of resources, one or more of the following:
a. a lead time,
b. a delivery date,
c. a latest date to order the resource for on-time project completion,
d. a current status,
e. the corresponding proposal,
f. a seller,
g. a manufacturer,
h. a specification, and
i. CSI Division for organizational and management purposes.

Method 2000 may then proceed to stage 2035: establishing a procurement schedule of the plurality of resources in accordance with the calculated resource data. The procurement schedule may include a time frame for purchasing one or more (e.g., each) of the resources specified in the plurality of resources. In some embodiments, the time frame may be based on one or more of an estimated time to complete the project, an estimated delivery time of the resource, and/or a current resource status. In one nonlimiting example, the time frame may further be based on an estimated and/or actual project start date or project milestone. In this stage, product and/or contractor data may integrate into the project and/or project management workflows.

Method 2000 may then proceed to stage 2040: establishing a project schedule. In some embodiments, one or more of the following may integrate into and/or be used as a basis for the project schedule:
a. the resource data from each of the plurality of resources,
b. the procurement schedule, and
c. each determined proposal.

Method 2000 may then proceed to stage 2045: determining a payment schedule for plurality of resources outlined in contract. In some embodiments, the payment schedule may comprise one or more of the following: a first payment arrangement for a developer of the project to a contractor of each of the determined proposals, and a second payment arrangement for the contractor to a supplier associated with each of the plurality of resources related to the contractor. In further embodiments, method 2035 may participate in purchasing one or more of the plurality of resources in accordance with the procurement schedule.

Method 2000 may then proceed to stage 2050: receiving an indication of a change relating to a particular resource, of the plurality of resources. The change may comprise one or more of the following:
a. an inventory deficiency,
b. a delivery date modification,
c. a lead time change, and
d. a cost change.

Method 2000 may then proceed to stage 2055: responsive to receiving the indication of the change (and in accordance with the change), updating at least a portion of the resource data, and/or adjusting one or more of the following: at least a portion of the procurement schedule, at least a portion of the project schedule, and at least a portion of the payment schedule. That is, stages 2035-2045 may be repeated based on the updated resource data. In further embodiments, any document and/or project management workflow where the updated resource is located may adjust accordingly. In further embodiments, wherein responsive to receiving the indication of the change, adjusting one or more of the following:
a. at least a portion of the procurement schedule,
b. at least a portion of the project schedule,
c. at least a portion of the payment schedule,
d. a submittal relating to the plurality of resources,
e. payment relating to the payment schedule, and
f. an invoicing date relating to the payment schedule.

In some embodiments, adjusting the procurement schedule may comprise adjusting the time frame for purchasing the particular resource. In some embodiments, adjusting the procurement schedule may also include adjusting a purchasing timeframe for one or more other resources. by way of nonlimiting example, one or more resources for use after the particular resource has been installed may be delayed based on a delay in procuring the particular resource and/or may be moved up based on a reduction in delivery time for the particular resource.

### IV. Computing Device Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 900. The computing device 900 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although methods 1000 and 2000 have been described to be performed by a computing device 900, it should be understood that, in some embodiments, different operations may be performed by a plurality of the computing devices 900 in operative communication on at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for redundancy, high availability, and/or performance purposes. The combination of the presently disclosed units is configured to perform the stages of any method disclosed herein.

FIG. 25 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 25. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, and the memory unit 940, consistent with embodiments of the disclosure.

At least one computing device 900 may be embodied as any of the computing elements illustrated in the attached figures, including the work opportunity module 200, the contract module 300, and the workflow module 400. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 25, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

In a system consistent with an embodiment of the disclosure the computing device 900 may include the clock module 910 may be known to a person having ordinary skill in the art as a clock generator, which produces clock signals. Clock signals may oscillate between a high and a low state at a controllable rate and may be used to synchronize or coordinate digital circuits' actions. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, a single-phase clock which transmits all clock signals on effectively 1 wire, a two-phase clock which distributes clock signals on two wires, each with non-overlapping pulses, and four-phase clock which distributes clock signals on 4 wires.

Many computing devices 900 may use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

In a system consistent with an embodiment of the disclosure the computing device 900 may include the CPU unit 920 comprising at least one CPU Core 921. A plurality of CPU cores 921 may comprise identical CPU cores 921, such as, but not limited to, homogeneous multi-core systems. It is also possible for the plurality of CPU cores 921 to comprise different CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 simultaneously. The CPU unit 920 may be integrated into at least one of a single integrated circuit die, and multiple dies into a chip package. The chip package may contain a plurality of other elements of the computing device 900, for example, but not limited to, the clock 910, the CPU 920, the bus 930, the memory 940, and I/O 960.

The CPU unit 920 may contain cache 922 such as but not limited to a level 1 cache, level 2 cache, level 3 cache, or combination thereof. The cache 922 may or may not be shared amongst a plurality of CPU cores 921. The cache 922 sharing may comprise at least one message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or an external plurality of hardware and software components, for example, but not limited to a wire, optical fiber, communication protocols, and any physical arrangement that provides the same logical function as a parallel electrical bus. The bus 930 may comprise at least one of, but not limited to, a parallel bus, wherein the parallel bus carries data words in parallel on multiple wires, and a serial bus, wherein the serial bus carry data in bit-serial form. The bus 930 may embody a plurality of topologies, for example, but not limited to, a multidrop/electrical parallel topology, a daisy chain topology, and a connected by switched hubs, such as a USB bus. The bus 930 may comprise a plurality of embodiments, for example, but not limited to:
Internal data bus (data bus) 931/Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 900 may employ hardware integrated circuits that store information for immediate use in the computing device 900, known to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher storage capacity. The contents contained in memory 940, may be transferred to secondary storage via techniques such as, but not limited to, virtual memory and swap. The memory 940 may be associated with addressable semiconductor memory, such as integrated circuits consisting of silicon-based transistors, that may be used as primary storage or for other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory, which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system may be known to a person having ordinary skill in the art as I/O module 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, humans, the environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using the intermediate area in the memory 940 in some configurations of the computing device 900. The non-volatile storage sub-module 961 may not lose data when power is removed and may be less costly than storage used in memory 940. Further, the non-volatile storage sub-module may have a slower speed and higher latency than in other areas of the computing device 900. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 900 may employ the communication sub-module 962 as a subset of the I/O 960, which may be referred to by a person having ordinary skill in the art as at least one of, but not limited to, computer network, data network, and network. The network may allow computing devices 900 to exchange data using connections, which may also be known to a person having ordinary skill in the art as data links, which may include data links between network nodes. The nodes may comprise network computer devices 900 that may be configured to originate, route, and terminate data. The nodes may be identified by network addresses and can include a plurality of hosts consistent with the embodiments of a computing device 900. Embodiments of the computing device may include, but not be limited to, personal computers, phones, servers, drones, and networking devices such as, but not limited to, hubs, switches, routers, modems, and firewalls.

Two nodes can be considered networked together when one computing device 900 can exchange information with another computing device 900, regardless of any direct connection between the computing devices 900. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, and may be known to a person having ordinary skill in the art as carried as payload, over other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanisms and organizational intent policies. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to nanoscale networks, Personal Area networks (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises at least one of the devices, modules, and subsystems whose purpose is to detect events or changes in its environment and send the information to the computing device 900. Sensors are sensitive to the measured property, may not detect any property not measured but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 900 may employ the peripherals sub-module 962 as a subset of the I/O 960. The peripheral sub-module 964 comprises ancillary devices uses to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 900. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 900 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network 962 sub-module), data storage devices (non-volatile storage 961), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Aspects

The following discloses various Aspects of the present disclosure. The various Aspects are not to be construed as patent claims unless the language of the Aspect appears as a patent claim. The Aspects describe various non-limiting embodiments of the present disclosure.

Aspect 1. Access to the project 150 may be tiered. All project team members will have access to the project profile. Non-members will have limited access.
Aspect 2. Work Opportunities may be embodied as project management tools within the that allow users to solicit, obtain, and manage proposals for a specific scope of work. Each work opportunity may represent the need for an outside consultant or contractor on a project. The time and resources that will be used to complete a scope of work, and more specifically, how much each item will cost, may be provided by the work opportunity. The estimate may only be accessible to the user(s) who created the work opportunity. Responsive to putting together an estimate, the user(s) may be able to search for professionals who fit the criteria for the work opportunity. The search functionality may be based on the work each user performs, location, qualifications, and/or industry. The work opportunity will also provide a list of suggested contractors. Further, a notification may be transmitted out to each contractor selected by the user. The notification may provide a means of access to the project profile and/or work opportunity sub-profile wherein a bid may be based off of.
Aspect 3. A draft contract uses a combination of built-in and/or integrated contract language, direct user input, and data associated with users, products, and/or the project to streamline and/or automate the contract creation process. Certain information such as “Banking Information”, “Parties”, “Project”, “Contract Dates”, “Scope of Work”, and/or “Schedule of Values” may be populated automatically. All or substantially all of the data may be integrated directly from the proposal selected and/or the user profile(s) and the parent/overall project. In some embodiments, the contract will not be executed until both parties have added a signature to the contract. A denial option may be used to amend, propose amendments, and/or send the contract back to the other party. A comment and/or reason may be required. Responsive to execution of the contract, all products and/or resources may be automatically added to the project. This may allow for both parties to manage the documents associated with each item. That is, resources from a contract may be integrated into the project& project management workflows, as described in sections above. All parties may also be able to manage approvals, delivery dates, order quantities, lead times (anticipate delays), and other relevant data. Upon execution of the contract, the project schedule may be updated to include all contract timelines and/or product delivery dates. Upon contract execution all parties and the individuals selected will have access to the project. Upon contract execution a payment schedule will be created based upon the payment structure outlined in the contract. Banking information for each party to the contract is tied to their account, each party will have the opportunity to confirm the preferred bank account for this contract. Since this information is all available, payment execution and/or invoicing may be automated. The aforementioned may also be added manually or automatically updated.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for providing curated work opportunities comprising:
receiving contractor bid data from a device associated with a contractor, the contractor bid data comprising information related to work the contractor is interested in performing;
receiving contractor legacy data relating to one or more past work opportunities, projects, and contracts associated with the contractor;
receiving a request, from the device associated with the contractor, for a recommendation of one or more work opportunities for which the contractor should apply, from a plurality of candidate work opportunities;
associating the contractor bid data and the contractor legacy data with one or more learned contractor profiles trained by an Artificial Intelligence (AI) engine;
establishing one or more parameters for assessing the plurality of candidate work opportunities based at least in part on one or more of the contractor bid data or the contractor legacy data;
analyzing each of the plurality of candidate work opportunities in accordance with the one or more parameters; and
providing, to the device associated with the contractor, the recommendation of one or more of the plurality of candidate work opportunities.

2. The method of claim 1, wherein the contractor bid data comprises one or more of the following:
a CSI division,
a scope of work,
a service performed,
one or more qualifications,
supporting documentation,
a geolocation,
one or more resources to be used, or
an availability time frame.

3. The method of claim 2, wherein each of the plurality of candidate work opportunities comprises one or more of the following:
one or more work types,
a CSI division,
a bid start date,
a start date,
one or more qualification requirements,
a geolocation,
an opportunity scope overview,
deliverables,
supporting documentation,
an internal cost estimate, or
a parent project.

4. The method of claim 3, wherein the one or more parameters for assessing the plurality of candidate work opportunities comprises a minimum correlation between the one or more learned contractor profiles associated with the contractor and each of the plurality of work opportunities.

5. The method of claim 3, wherein the one or more parameters for assessing the plurality of candidate work opportunities comprises a predetermined range of association of one or more weighted factors between the one or more learned contractor profiles and each of the plurality of work opportunities.

6. The method of claim 5, wherein the one or more weighted factors are determined based on input from the device associated with the contractor.

7. The method of claim 3, wherein the recommendation comprises the single work opportunity, of the plurality of candidate work opportunities, that most closely matches the input from the device associated with the contractor.

8. The method of claim 3, wherein the recommendation comprises the one or more work opportunities, of the plurality of candidate work opportunities, that meet the one or more parameters for assessing the plurality of candidate work opportunities.

9. The method of claim 3, wherein the one or more candidate work opportunities are stored at a marketplace of an online platform.

10. The method of claim 9, wherein at least one of the one or more resources to be used is accessible via the marketplace.

11. One or more non-transitory computer readable media comprising instructions which, when executed by one or more hardware processors, causes performance of operations for providing curated work opportunities, the operations comprising:
receiving contractor bid data from a device associated with a contractor, the contractor bid data comprising information related to work the contractor is interested in performing;
receiving contractor legacy data relating to one or more past work opportunities, projects, and contracts associated with the contractor;
receiving a request, from the device associated with the contractor, for a recommendation of one or more work opportunities for which the contractor should apply, from a plurality of candidate work opportunities;
associating the contractor bid data and the contractor legacy data with one or more learned contractor profiles trained by an Artificial Intelligence (AI) engine;
establishing one or more parameters for assessing the plurality of candidate work opportunities based at least in part on one or more of the contractor bid data or the contractor legacy data;
analyzing each of the plurality of candidate work opportunities in accordance with the one or more parameters; and
providing, to the device associated with the contractor, the recommendation of one or more of the plurality of candidate work opportunities.

12. The computer readable media of claim 11, wherein the contractor bid data comprises one or more of the following:
a CSI division,
a scope of work,
a service performed,
one or more qualifications,
supporting documentation,
a geolocation,
one or more resources to be used, or
an availability time frame.

13. The computer readable media of claim 12, wherein each of the plurality of candidate work opportunities comprises one or more of the following:
one or more work types,
a CSI division,
a bid start date,
a start date,
one or more qualification requirements,
a geolocation,
an opportunity scope overview,
deliverables,
supporting documentation,
an internal cost estimate, or
a parent project.

14. The computer readable media of claim 13, wherein the one or more parameters for assessing the plurality of candidate work opportunities comprises a minimum correlation between the one or more learned contractor profiles associated with the contractor and each of the plurality of work opportunities.

15. The computer readable media of claim 13, wherein the one or more parameters for assessing the plurality of candidate work opportunities comprises a predetermined range of association of one or more weighted factors between the one or more learned contractor profiles and each of the plurality of work opportunities.

16. The computer readable media of claim 15, wherein the one or more weighted factors are determined based on input from the device associated with the contractor.

17. The computer readable media of claim 13, wherein the one or more candidate work opportunities are stored at a marketplace of an online platform.

18. The computer readable media of claim 17, wherein at least a portion of the contractor bid data is accessible via the marketplace.

19. A system comprising:
at least one device including a hardware processor;
the system being configured to perform operations for providing curated work opportunities, the operations comprising:
receiving contractor bid data from a device associated with a contractor, the contractor bid data comprising information related to work the contractor is interested in performing;
receiving contractor legacy data relating to one or more past work opportunities, projects, and contracts associated with the contractor;
receiving a request, from the device associated with the contractor, for a recommendation of one or more work opportunities for which the contractor should apply, from a plurality of candidate work opportunities;
associating the contractor bid data and the contractor legacy data with one or more learned contractor profiles trained by an Artificial Intelligence (AI) engine;
establishing one or more parameters for assessing the plurality of candidate work opportunities based at least in part on one or more of the contractor bid data or the contractor legacy data;
analyzing each of the plurality of candidate work opportunities in accordance with the one or more parameters; and
providing, to the device associated with the contractor, the recommendation of one or more of the plurality of candidate work opportunities.

20. The system of claim 19, wherein the one or more parameters for assessing the plurality of candidate work opportunities comprise one of more of:
a minimum correlation between the one or more learned contractor profiles associated with the contractor and each of the plurality of work opportunities, or
a predetermined range of association of one or more weighted factors between the one or more learned contractor profiles and each of the plurality of work opportunities.
